(19) United States
(12) Patent Application Publication
(10) Pub. No.: US 2024/0408840 A1
(43) Pub. Date: Dec. 12, 2024

(54) REINFORCING MATERIAL COMPRISING A POROUS LAYER MADE OF A REACTIVE THERMOPLASTIC POLYMER AND ASSOCIATED METHODS

(71) Applicant: HEXCEL REINFORCEMENTS SASU, Dagneux (FR)

(72) Inventors: Thibaut BENETHUILIERE, Bregnier Cordon (FR); Andréa VIARD, Villemoirieu (FR); Quentin PINEAU, Evreux (FR); Patrick DANG, Sotteville-Les-Rouen (FR)

(73) Assignee: HEXCEL REINFORCEMENTS SASU, (omitted)

(21) Appl. No.: 18/702,740

(22) PCT Filed: Oct. 20, 2022
(86) PCT No.: PCT/FR2022/051976

§ 371 Date: Apr. 18, 2024

(30) Foreign Application Priority Data
Oct. 21, 2021 (FR) FR2111188
Oct. 21, 2021 (FR) FR2111190

(51) Int. Cl. B32B 5/02; B32B 3/08; B32B 5/06; B32B 5/26; C08J 5/24; D04H 1/4334; D04H 3/16

(52) U.S. Cl. CPC B32B 5/028; B32B 3/085; B32B 5/022; B32B 5/073; B32B 5/268; B32B 5/273; C08J 5/246; D04H 1/4334; D04H 3/16; B32B 2250/20; B32B 2262/0261; B32B 2262/106; C08J 2363/00; C08J 2477/06; D10B 2505/02

(57) ABSTRACT

The present invention concerns a reinforcing material comprising at least one fibrous reinforcement associated on at least one of its faces with a thermoplastic porous layer, said thermoplastic porous layer(s) representing at most 10% of the total mass of the reinforcing material, preferably from 0.5 to 10% of the total mass of the reinforcing material, and more preferably from 2 to 6% of the total mass of the reinforcing material, characterized in that said thermoplastic porous layer or each of said thermoplastic porous layers present comprises a so-called reactive thermoplastic polymer or consists of one or more reactive thermoplastic polymers, a reactive thermoplastic polymer carrying —NH2 functions in an amount greater than 0.15 meq/g of reactive thermoplastic polymer and/or carrying —COOH functions in an amount greater than 0.20 meq/g of reactive thermoplastic polymer.

The invention also concerns processes for manufacturing such reinforcement materials, preforms, processes for manufacturing composite parts and composite parts using such reinforcement materials.

### TECHNICAL FIELD

The present invention relates to the technical field of reinforcing materials, suitable for the creation of composite parts. More specifically, the subject of the invention is reinforcing materials, suitable for making composite parts in association with an injected or infused resin.

### PREVIOUS TECHNIQUE

The manufacture of composite parts or articles, i.e. comprising, on the one hand, one or more fibrous reinforcements, in particular of the unidirectional fibrous web type and, on the other hand, a matrix (which is, in most cases, mainly of the thermosetting type and may include one or more thermoplastics) can, for example, be carried out by a so-called “direct” or “LCM” (from the English “Liquid Composite Molding”) process. A direct process is defined by the fact that one or more fibrous reinforcements are processed in a “dry” state (i.e. without the final matrix), the resin, or matrix, being processed separately, for example, by injection into the mold containing the fibrous reinforcements (“RTM” process, from the English “Resin Transfer Molding”), by infusion through the thickness of the fibrous reinforcements (Liquid Resin Infusion or Resin Film Infusion), or by manual coating/impregnation using a roller or brush, on each of the individual layers of fibrous reinforcements applied successively to the shape. In the manufacture of composite parts, particularly in the aeronautics industry, mass production rates can be high. For example, for the manufacture of single-aisle aircraft, aeronautics contractors want to be able to produce several dozen aircraft per month. Direct processes such as infusion or injection molding are of great interest in meeting this requirement.

RTM, LRI or RFI processes generally involve first manufacturing a fibrous preform or stack in the shape of the desired finished article, then impregnating this preform or stack with a resin to form the matrix. The resin is injected or infused by means of a temperature pressure differential, then once the entire quantity of resin required is contained in the preform, the assembly is brought to a higher temperature to perform the polymerization/crosslinking cycle and thus bring about its hardening.

Composite parts used in the automotive, aeronautics and naval industries are subject to particularly stringent requirements, especially in terms of mechanical properties. To save fuel and facilitate part maintenance, the aeronautics industry has replaced many metallic materials with lighter-weight composites.

The resin used to make the part, particularly by injection or infusion, can be a thermosetting resin, such as epoxy (also known as epoxide). The major drawback of these resins is their brittleness, which results in low impact resistance of the composite parts produced. It has therefore been proposed in the prior art to associate the fibrous reinforcement layers with porous thermoplastic polymer layers, and in particular with a non-woven fabric (also known as veil) of thermoplastic fibers. Such solutions are proposed in particular in the following documents: EP 1125728, U.S. Pat. No. 6,828,016, US 2010/003881, WO 00/58083, WO 2007/015706, WO 2006/121961, U.S. Pat. No. 6,503,856, US 2008/7435693, WO 2010/046609, WO 2010/061114, EP 2 547 816, US 2008/0289743, US 2007/8361262, US 2011/9371604 and WO 2011/048340.

Multiaxial reinforcements, commonly referred to as non-crimp fabrics (NCFs), are also ideally suited to direct processes. Such multiaxial reinforcements, consisting of a stack of several unidirectional webs of reinforcing fibers (in particular, carbon, glass or aramid) arranged in several orientations and sewn together, are described in particular in EP 2 547 816 and WO 2010/067003. Here too, porous polymeric layers are usually inserted into the NCFs to improve the mechanical properties of the composite parts produced.

However, these solutions have a number of drawbacks. The porous thermoplastic layers used usually have a high melting point, in particular above 150° C., which makes the manufacturing process for these reinforcement materials costly. Furthermore, the thermoplastic material making up the porous layer can interact with the thermosetting resin injected during the manufacture of composite parts, this being all the more marked the lower the melting point of the thermoplastic material making up the porous layer.

Above all, these porous thermoplastic layers are usually meltable in the resin during curing of the composite part. The consequences are that the thermoplastic porous layers can modify the local stoichiometry of the thermosetting resin, and that they can spread into the fibrous reinforcements when the latter are impregnated with the thermosetting resin. This is something we want to avoid, as it leads to an alteration in the temperature resistance properties of the parts obtained. It is therefore necessary to find an appropriate curing cycle (defined as the rate of temperature rise up to the part's curing temperature and the holding time at curing temperature) to enable the resin to gel at a temperature below or above the melting temperature of the thermoplastic porous layers, depending on whether the thermoplastic porous layer is to be kept intact or altered, resulting in different final properties of the part obtained.

Finally, another drawback of the porous thermoplastic layers proposed in the prior art is the sensitivity of the thermoplastics used to prolonged exposure to temperature.

In an attempt to overcome these drawbacks, other solutions have been proposed in the prior art: in order to be able to carry out the fiber reinforcement shaping step at lower cost and in less time, the applicant has proposed using an epoxy powder such as that used for the fabric developed under reference Hexcel Primetex 43098 S 1020 S E01 1F, instead of a thermoplastic porous layer. Such a thermosetting layer, obtained by depositing an epoxy powder with a softening temperature of around 100° C., enables composite parts to be produced faster and more cheaply, and in particular at a lower temperature, since low-temperature preforming can be carried out. Nevertheless, such a technique poses practical problems due to the use of powder, which tends to clog the dispensing heads of the automated dispensing devices used, and above all does not enable satisfactory properties to be achieved in terms of mechanical strength.

In patent application WO 2019/102136, the applicant also proposed associating fibrous reinforcement layers with porous thermoplastic polymer layers partially cross-linked under irradiation, so as to retain the beneficial effects on mechanical performance observed when using reinforcement materials comprising a porous thermoplastic layer. In particular, due to its partially cross-linked part, the porous layer will be only partially meltable, or even totally unmeltable, in the thermosetting resin, thus avoiding alteration of temperature and humidity resistance properties. In addition, the use of such porous thermoplastic polymer layers, partially cross-linked under irradiation, offers the possibility of carrying out the manufacturing process of the reinforcing material, and also its shaping during the production of composite parts, at temperatures below 130° C., preferably below 120° C. However, using an irradiation process to partially crosslink the thermoplastic material lengthens the overall process and increases costs.

The aim of the present invention is to provide new reinforcing materials for the production of composite parts by direct process, in particular of the RTM type, which make it possible to achieve satisfactory mechanical performance, in particular as required by the aerospace and aviation industries, and good resistance to temperature stress, without the technical constraints posed by the previous solutions previously proposed in application WO 2019/102136.

### OBJECT OF THE INVENTION

The invention relates to a reinforcing material comprising at least one fibrous reinforcement associated on at least one of its faces with a thermoplastic porous layer, said thermoplastic porous layer(s) representing at most 10% of the total mass of the reinforcing material, preferably from 0.5 to 10% of the total mass of the reinforcing material, and more preferably from 2 to 6% of the total mass of the reinforcing material, wherein said thermoplastic porous layer or each of said thermoplastic porous layers present comprises a so-called reactive thermoplastic polymer or consists of one or more reactive thermoplastic polymers, a reactive thermoplastic polymer carrying —NH2 functions in an amount greater than 0.15 meq/g of reactive thermoplastic polymer and/or carrying —COOH functions in an amount greater than 0.20 meq/g of reactive thermoplastic polymer.

In the context of the invention, due to the reactive —NH2 and COOH functions present in sufficient quantity on the reactive thermoplastic polymer of the porous layer present in the reinforcing material, the latter will be able to react in a controlled manner with epoxy resins, during curing, which will enable a certain integrity to be maintained in the thermoplastic layer, and thus reduce sensitivity to temperature exposure, as well as improving temperature properties for materials used in the aerospace industry.

Advantageously, in the reinforcing material according to the invention, said reactive thermoplastic polymer carries —NH₂ functions in an amount greater than 0.20 meq/g of reactive thermoplastic polymer, preferably in the range from 0.20 to 1 meq/g of reactive thermoplastic polymer and more preferably in the range from 0.20 to 0.95 meq/g of reactive thermoplastic polymer, and/or carries —COOH functions in an amount greater than 0.20 meq/g of reactive thermoplastic polymer, preferably in the range from 0.20 to 1 meq/g of reactive thermoplastic polymer and more preferably in the range from 0.20 to 0.95 meq/g of reactive thermoplastic polymer.

According to preferred embodiments, said reactive thermoplastic polymer of said thermoplastic porous layer(s) present within the reinforcing material has a melting temperature below 170° C., or even below 150° C. and preferably is in the range from 100 to 140° C., and more preferably in the range from 100 to 130° C.

Indeed, the reaction of the porous layer's thermoplastic polymer with the injected or infused resin will enable the use of a porous layer with a low melting temperature, and thus enable the use of a low temperature during manufacture and also during shaping of the reinforcement material, and thus a saving in terms of cost and time. A further advantage is that the melting temperature of the porous layer's reactive thermoplastic polymer can be lower than 170° C., or even 150° C. or less, enabling all stages of the manufacturing process prior to the addition of the resin ultimately required to produce the part (from preparation of the dry material, through its deposition and preforming) to be carried out at a temperature below 170° C., and even better below 150° C., or even less. Such porous layers comprising a reactive thermoplastic polymer with a lower melting point will enable the reinforcing material associating porous layer(s) and fibrous reinforcement(s) to be manufactured at a temperature compatible with automated manufacturing processes, in particular fiber placement and hot forming of flat-laid preforms.

The secondary aim of the present invention is therefore to combine the beneficial effects of using a thermoplastic porous layer on impact resistance performance, with the possibility of carrying out all the steps in the manufacturing process prior to resin infusion or injection, at temperatures below 170° C., or even below 150° C. or 140° C., these temperatures even being in some cases in the range from 100 to 130° C., or even from 80 to 140 or 130° C.

Particularly preferred in the context of the invention, in the reinforcing material, the reactive thermoplastic polymer is a polyamide or copolyamide carrying said-NH2 and/or —COOH functions.

In particular, the said thermoplastic porous layer(s) present comprise(s) —NH₂ functions in an amount greater than 0.15 meq/g of porous layer and/or —COOH functions in an amount greater than 0.20 meq/g of porous layer.

According to particular embodiments, the reactive thermoplastic polymer has a number-average molecular weight Mn greater than 4000 g/mol.

In reinforcement materials according to the invention, the fibrous reinforcement can take different forms. In some embodiments, the fibrous reinforcement is a unidirectional web of reinforcing yarns, a fabric of reinforcing yarns or a stack of unidirectional webs of reinforcing yarns bonded together by sewing or any other physical means, such as needling.

The fibrous reinforcement can, in particular, consist of glass fibers, aramid fibers or, preferably, carbon fibers.

According to certain embodiments, a reinforcing material according to the invention consists of a unidirectional web of reinforcing yarns corresponding to the fibrous reinforcement, associated on at least one of its faces with a thermoplastic porous layer as defined within the context of the invention, preferably said fibrous reinforcement material consisting of a unidirectional web of reinforcing yarns corresponding to the fibrous reinforcement, associated on each of its faces with a thermoplastic porous layer as defined within the context of the invention, and the thermoplastic porous layers present on each of the faces of the unidirectional web of reinforcing yarns being identical.

The said thermoplastic porous layer(s) of the reinforcing materials according to the invention can have a hot tackiness and the association of the fibrous reinforcement and the said porous layer could be achieved thanks to the hot tackiness of the said thermoplastic porous layer.

According to some embodiments, a reinforcing material according to the invention consists of a stack of unidirectional webs of reinforcing yarns, as fibrous reinforcements, oriented in different directions, with at least one thermoplastic porous layer as defined within the context of the invention, interposed between two unidirectional webs of reinforcing yarns and/or on the surface of the stack. Such a stack may consist of a superposition of layers corresponding to a sequence (CP/R)ₙ (CP)ₘ or (CP/R/CP)ₙ with CP designating a porous thermoplastic layer as defined within the context of the invention, R a unidirectional web, n an integer greater than or equal to 1 and m equal to 0 or 1. In such stacks, the unidirectional webs of reinforcing yarns can be associated with each other, or with the at least one thermoplastic porous layer, by sewing, knitting or needling.

In reinforcing materials according to the invention, the said thermoplastic porous layer(s) present is (are), in particular, a porous film, a grid, a powder deposit, a fabric or, preferably, a non-woven or veil.

Another object of the invention is a process for preparing a reinforcing material according to the invention, characterized in that it comprises the following successive steps:
a1) providing a fibrous reinforcement,
a2) providing at least one porous thermoplastic layer comprising a so-called reactive thermoplastic polymer, or consisting of one or more reactive thermoplastic polymers, a reactive thermoplastic polymer carrying —NH₂ functions in an amount greater than 0.15 meq/g of reactive thermoplastic polymer and/or carrying —COOH functions in a quantity greater than 0.20 meq/g of reactive thermoplastic polymer,
a3) associating the fibrous reinforcement and the at least one porous thermoplastic layer.

In such a preparation process, the association of step a3) is advantageously achieved by applying the at least one porous thermoplastic layer to the fibrous reinforcement, said application being accompanied or followed by heating of said reactive thermoplastic polymer causing its softening or melting, then followed by cooling, said heating preferably being carried out at a temperature below 170° C., or even 150° C. and more preferably in the range 80 to 140° C., especially 100 to 140° C., and preferably in the range 80 to 130° C., especially 100 to 130° C. Of course, the thermoplastic polymer(s) of the thermoplastic porous layer are chosen so as to soften or melt at such a temperature.

Another object of the invention is a preform consisting, at least in part, of one or more reinforcing materials according to the invention.

Another object of the invention relates to a process for manufacturing a composite part from at least one reinforcing material according to the invention, in which an epoxy thermosetting resin is injected or infused into said reinforcing material according to the invention, a stack of several reinforcing materials according to the invention, or a preform according to the invention.

Advantageously, the process for manufacturing a composite part according to the invention comprises, once the epoxy thermosetting resin has been injected or infused into said reinforcing material or said stack, a heat treatment step, comprising heating to a temperature Ta, leading to cross-linking of the epoxy resin and consolidation of the composite part, during which the epoxy resin reacts with at least some of the —NH2 and/or —COOH functions present on the reactive thermoplastic polymer of the thermoplastic porous layer(s).

In particular, the gelling of the epoxy resin takes place during the heat treatment step and the —NH2 and/or —COOH functions react with said resin before the latter gels.

According to a first variant of the manufacturing process of a composite part according to the invention, said temperature Ta is higher than the melting temperature of said reactive thermoplastic polymer of said at least one thermoplastic porous layer. In particular, heating to said temperature Ta is carried out during the heat treatment step for 5 minutes to 2 hours. Most often, the heat treatment step comprises a temperature rise phase, in particular at a rate of 0.1 to 10° C./minute, up to said temperature Ta. Preferably, the viscosity of the epoxy thermosetting resin increases between the melting of said reactive thermoplastic polymer of said at least one thermoplastic porous layer and the initiation of crosslinking of the epoxy thermosetting resin. More rigorously, we could say that the viscosity that is increased is that of the system resulting from the reaction between the reactive polymer of the thermoplastic porous layer and the epoxy resin.

According to the first implementation variant, during the heat treatment step, gelling of the epoxy thermosetting resin occurs earlier than if the latter were subjected to the heat treatment step on its own. In particular, during heating to temperature Ta, gelling of the epoxy thermosetting resin takes place after a heating time of 5 minutes to 60 minutes.

According to the first variant of the manufacturing process of a composite part according to the invention where the temperature Ta is higher than the melting temperature of said reactive thermoplastic polymer of said at least one thermoplastic porous layer, the thermosetting resin has, preferably, a glass transition temperature Tg higher than 150° C.

According to a second variant of the manufacturing process of a composite part according to the invention, said temperature Ta is lower than the melting temperature of said reactive thermoplastic polymer of said thermoplastic porous layer, and a heating at said temperature Ta. In particular, heating at said temperature Ta for 5 minutes to 5 hours is carried out during the heat treatment step. Preferably, gelling of the thermosetting epoxy resin occurs earlier than if the latter were subjected to the heat treatment step alone. Here again, the heat treatment step generally comprises a temperature rise phase, in particular at a rate of 0.1 to 10° C./minute, up to said temperature Ta.

According to the second variant of the manufacturing process of a composite part according to the invention where the temperature Ta is lower than the melting temperature of said reactive thermoplastic polymer of said at least one thermoplastic porous layer, the thermosetting resin has, preferably, a glass transition temperature Tg at least equal to 100° C., and advantageously in the range from 100 to 150° C.

Also advantageously, according to the second variant of the manufacturing process of a composite part according to the invention where the temperature Ta is lower than the melting temperature of said reactive thermoplastic polymer of said at least one thermoplastic porous layer, said reactive thermoplastic polymer has a melting temperature higher than 120° C.

Whatever the variant used to manufacture a composite part according to the invention, the temperature Ta is in the range from 120 to 220° C., preferably in the range from 160 to 220° C., more preferably in the range from 170 to 190° C., and is typically 180° C.

Advantageously, in the processes for manufacturing a composite part according to the invention, the epoxy thermosetting resin has a viscosity of less than 1000 mPa·s at a temperature of 90° C.

In addition, processes for manufacturing a composite part according to the invention may include, prior to infusion or injection of said epoxy thermosetting resin, deposition or shaping of said reinforcing material(s), which preferably utilizes the hot tackiness of said at least one thermoplastic porous layer present in said reinforcing material(s) and implements heating, preferably carried out at a temperature below 170° C., or even 150° C. and preferably is in the range from 100 to 140° C., and more preferably in the range from 100 to 130° C.

The invention also covers composite parts obtained by a manufacturing process as defined within the context of the invention.

The invention therefore concerns composite parts which comprise a thermoset epoxy matrix in which is included at least one reinforcing material comprising at least one fibrous reinforcement associated on at least one of its faces with a thermoplastic porous layer, said thermoplastic porous layer(s) representing at most 10% of the total mass of the reinforcing material, preferably from 0.5 to 10% of the total mass of the reinforcing material, and more preferably from 2 to 6% of the total mass of the reinforcing material. In said composite parts, covalent bonds exist between the thermoset epoxy matrix and the thermoplastic polymer present within the thermoplastic porous layer(s), said covalent bonds resulting from the reaction of —NH2 and/or —COOH functions that were present on said thermoplastic polymer and epoxy resin.

### Definitions

By “porous layer” we mean a permeable layer that allows a liquid, such as a resin, to pass through the material when it is injected or infused into a preform or composite part during creation thereof. In particular, the opening factor of such a layer is in the range 30-99%, preferably 40-70%. Such an opening factor, a conventional parameter for characterizing such a porous layer, can be determined using any technique known to the person skilled in the art, in particular using the method described in application WO 2011/086266. Examples of porous layers include porous films, grids made by interweaving yarns, layers obtained by powder deposition, fabrics and non-wovens. However, in the context of the invention, whatever the method described, it is preferable to use a porous layer in the form of a non-woven fabric, also known as a veil, which makes it possible to produce composite parts with particularly satisfactory mechanical properties.

The porous layer is said to be thermoplastic, as it contains a thermoplastic polymer and is, advantageously, essentially or solely consisting of a thermoplastic polymer or a blend of thermoplastic polymers. When the porous layer comprises several polymers, these may be present in a mixture within the layer, in particular within a porous film, a powder, or fibers forming the porous layer. It is also possible to use fibers having a core and a sheath around the core, to form the porous layer, the core and sheath being in different polymers, and in particular one or more reactive thermoplastic polymers defined within the context of the invention forming the sheath. The porous layer may also comprise a thermoplastic binder in one or more reactive thermoplastic polymers defined within the context of the invention, in particular with a lower melting point than the rest of the polymer(s) forming the porous layer. The porous layer is said to consist essentially of a thermoplastic polymer or a blend of such polymers, if said polymer or said blend represents at least 90% by mass, preferably at least 95% by mass of the mass of the thermoplastic porous layer. In the present description, the thermoplastic porous layer may more simply be referred to as a “porous layer”, for the sake of simplicity. In particular, the porous layer may consist essentially or solely of a reactive thermoplastic polymer, in particular selected from polyesters, copolyesters, polyamide-imides, polyethersulfones, polyimides, polyetherketones, polymethyl methacrylates, aromatic polyethers, polyamides and copolyamides, which carry —NH2 functions in a quantity greater than 0.15 meq/g of reactive thermoplastic polymer and/or —COOH functions in a quantity greater than 0.20 meq/g of reactive thermoplastic polymer, or a mixture of such polymers. Such polymers can therefore comprise either only —NH2 functions in an amount greater than 0.15 meq/g of reactive thermoplastic polymer, or only —COOH functions in an amount greater than 0.20 meq/g of reactive thermoplastic polymer, or —NH2 functions in an amount greater than 0.15 meq/g of reactive thermoplastic polymer and —COOH functions in an amount greater than 0.20 meq/g of reactive thermoplastic polymer.

In the context of the invention, when reference is made to meq/g of reactive thermoplastic polymer, the mass of reactive thermoplastic polymer includes the reactive functions present on said polymer.

In the context of the invention, for the sake of simplicity, a reactive thermoplastic polymer, in particular chosen from polyesters, copolyesters, polyamide-imides, polyethersulfones, polyimides, polyetherketones, polymethyl methacrylates, aromatic polyethers, polyamides and copolyamides, which carry —NH2 functions in a quantity greater than 0.15 meq/g of reactive thermoplastic polymer and/or —COOH functions in a quantity greater than 0.20 meq/g of reactive thermoplastic polymer, can simply be called reactive thermoplastic polymers. Thus, the above-mentioned reactive thermoplastic polymers can either carry —NH2 functions in a quantity greater than 0.15 meq/g of reactive thermoplastic polymer, or carry —COOH functions in a quantity greater than 0.20 meq/g of reactive thermoplastic polymer, or carry both-NH2 functions in a quantity greater than 0.15 meq/g of reactive thermoplastic polymer and —COOH functions in a quantity greater than 0.20 meq/g of reactive thermoplastic polymer. In the reactive thermoplastic polymers used in the context of the invention, —NH2 and/or —COOH functions, which can be described as free functions or reactive functions, are present on said thermoplastic polymer in sufficient quantity to achieve covalent reactions with the epoxy resin used during the production of a composite part, so as to maintain the integrity or a certain integrity of the thermoplastic porous layer, or at least limit its mobility in the resin infused or injected during the subsequent production of a composite part. In this way, there are no adverse effects on the mechanical properties of the resulting composite part.

In particular, a reactive thermoplastic polymer used in the context of the invention comprises free —COOH functions, in an amount greater than 0.20 meq/g of reactive thermoplastic polymer, in particular in an amount greater than or equal to 0.22; 0.25; 0.30 or 0.40 meq/g of reactive thermoplastic polymer; preferably in the range from 0.20 to 1 meq/g reactive thermoplastic polymer and more preferably in the range from 0.20 to 0.95 meq/g reactive thermoplastic polymer, especially in the range from 0.20 to 0.60 meq/g reactive thermoplastic polymer, in the range from 0.20 to 0.50 meq/g reactive thermoplastic polymer, or, even more preferably, in the range from 0.22 to 0.46 meq/g reactive thermoplastic polymer. In particular, a reactive thermoplastic polymer used in the context of the invention comprises free —NH2 functions, in an amount greater than 0.20 meq/g of reactive thermoplastic polymer, particularly in an amount greater than or equal to 0.25; 0.30 or 0.34 meq/g of reactive thermoplastic polymer; preferably in the range from 0.20 to 1 meq/g of reactive thermoplastic polymer and more preferably in the range from 0.20 to 0.95 meq/g, in particular in the range from 0.20 to 0.60 meq/g of reactive thermoplastic polymer; in the range from 0.30 to 0.50 meq/g reactive thermoplastic polymer, in the range from 0.30 to 0.40 meq/g reactive thermoplastic polymer, or, even more preferably, in the range from 0.32 to 0.36 meq/g reactive thermoplastic polymer. The said quantities of —COOH or —NH2 functions can be present alone or together, in any possible combination, on a reactive thermoplastic polymer.

It is also possible for the porous layer to consist essentially or solely of one or more reactive thermoplastic polymers, blended with another so-called additional thermoplastic polymer. In this case, preferably, the mass of the reactive thermoplastic polymer(s) represents at least 10%, more preferably at least 70%, of the total mass of the thermoplastic porous layer. Examples of polymers other than reactive thermoplastic polymers include polyamides, copolyamides, polyesters, copolyesters, polyamide-imides, polyethersulfones, polyimides, polyetherketones, polymethyl methacrylates, and aromatic polyethers (not comprising —NH2 or —COOH functions or comprising such functions in lesser quantities than those envisaged in the context of the invention) . . . .

Said additional thermoplastic polymer may have a melting temperature below 170° C., or even 150° C., and preferably in the range from 100 to 140° C., and more preferably in the range from 100 to 130° C. In such cases, advantageously, the reactive porous layer consists of at least 70% by mass, preferably at least 80% by mass, and more preferably at least 90% by mass of one or more reactive thermoplastic polymer(s) as defined in the context of the invention.

It is also possible to use fibers with a core made of one or more so-called additional thermoplastic polymer(s) having a melting temperature below 170° C., or even 150° C. and preferably is in the range from 100 to 140° C., and more preferably in the range from 100 to 130° C., said core being surrounded by a sheath, with one or more reactive thermoplastic polymers defined within the context of the invention constituting the sheath. Said additional thermoplastic polymer may also have a melting temperature above 170° C., or even 180° C., preferably in the range 180-220° C. In such cases, advantageously, the reactive thermoplastic polymer(s) as defined within the context of the invention may be present within the porous layer to serve as a binder, in particular to bind the thermoplastic porous layer to the fibrous reinforcement, and the reactive thermoplastic polymer(s) as defined within the context of the invention may be present in smaller quantities within the porous layer, in particular representing from 10 to 30% of the mass of the porous layer.

In the context of the invention, the polymeric material constituting the porous layer is preferably a reactive thermoplastic polymer or a blend of such reactive thermoplastic polymers, and not a blend of one or more of these polymers with another thermoplastic polymer.

In the context of the invention, and whatever the implementation variant, the reactive thermoplastic polymer is preferably a polyamide or copolyamide, carrying-NH2 functions in a quantity greater than 0.15 meq/g of reactive thermoplastic polymer and/or —COOH functions in a quantity greater than 0.20 meq/g of reactive thermoplastic polymer, and in particular carrying —NH2 and/or —COOH functions in the quantities previously specified in the more general description of reactive thermoplastic polymers.

The reactive thermoplastic polymer used in the context of the invention carries a sufficient quantity of reactive functions to enable it to react with the epoxy thermosetting resins conventionally used in the manufacture of composite parts. As will become apparent from the examples, such a reaction will make it possible to confer particularly advantageous characteristics on the composite parts obtained, in particular to improve temperature and moisture resistance properties, while retaining satisfactory mechanical properties of importance for composite parts intended for the aeronautics and aerospace industries.

The quantity of reactive —COOH or —NH2 functions present can be assessed by potentiometric titration: the quantity of —COOH functions is determined by acid-base assay of the porous layer with tetra-n-butylammoniumhydroxide ((CH)₄₉₄_{⁺}NOH⁻) in alcoholic solution, that of —NH2 functions is determined by assay with perchloric acid (HClO₄) in acetic acid, as detailed in the examples. Results are expressed in meq/g (milliequivalents per gram).

The reactive thermoplastic polymer used in the context of the invention is advantageously a polyamide or copolyamide. In particular, the reactive thermoplastic polymer is in the form of a branched polyamide or copolyamide carrying an —NH2 or —COOH function at the end of the branch chain, so as to achieve the quantities of functions targeted within the context of the invention. This may be a polyamide 6 (polycaprolactam), 6.6 (nylon), 6.10 (polyhexamethylene sebacamide) 6.12 (polyhexamethylene dodecanediamide) 11 (polyundecanamide), 12 (polylauroamide), in particular. Advantageously, the reactive thermoplastic polymer belongs to the copolyamide family, in particular copolymers of caprolactam and/or lauryllactam and/or hexamethylenediamine and adipic acid.

Such polymers are marketed in particular by ARKEMA France, under the Platamid® HX2598 and H2651 brand names, by Evonik Industries AG (Germany), by Solvay (Belgium) and by EMS-Grivory (Switzerland).

Conventionally, as described in EP3197974, FR2883878 and US2010/0032629, polyamides or copolyamides can be obtained from several raw materials: lactams, aminocarboxylic acids, diamines or triamines, dicarboxylic acids, etc. The production of a copolyamide requires the selection of at least two of these products. The quantities of diamines and diacids used modulate the amine and acid functions present in the polyamide or copolyamide.

Examples of lactams are those with 3 to 12 carbon atoms on the main ring, which can be substituted. Examples include caprolactam, capryllactam, lauryllactam, amylolactam, etc.

Examples of aminocarboxylic acids include amino-undecanoic acid and aminododecanoic acid.

Examples of dicarboxylic acids include adipic acid, isophthalic acid, sebacic acid, dodecanedioic acid, theraphthalic acid, etc.

Examples of diamines include those with 6 to 12 carbon atoms, aryls and saturated cyclics. Examples include hexamethylene diamine, tetramethylene diamine, octamethylene diamine, decamethylene diamine, piperazine, etc.

Examples of copolyamide linkages include caprolactam and lauryl lactam (6/12), caprolactam, lauryl lactam and amino 11 undecanoic acid (6/11/12), caprolactam, adipic acid and hexamethylene diamine (6/66), caprolactam, lauryllactam, adipic acid and hexamethylene diamine (6/12/66), caprolactam, lauryllactam, amino 11 undecanoic acid, adipic acid and hexamethylene diamine (6/66/11/12).

In particular, suitable quantities of acid such as adipic acid (for the introduction of —COOH functions) and/or amine such as hexamethylenediamine (for the introduction of amine functions) are brought into play, in order to modulate and achieve the desired number of reactive functions.

More generally, for all thermoplastic polymers, a preferred solution for introducing amine —NH2 or acid —COOH functions is plasma treatment. The implementation of such treatments is in particular described in the following documents: Grafting of Chemical Groups onto Polymers by Means of RF Plasma Treatments: a Technology for Biomedical Applications, P. Favia, R. d'Agostino, F. Palumbo, J. Phys. IV France 07 (1997) C4-199-C4-208; publication Plasma grafting—a method to obtain monofunctional surfaces, C. Oehr, M. Müller, B. Elkin, D. Hegemann, U. Vohrer, Surface and Coatings Technology Volumes 116-119, September 1999, Pages 25-35; US2021/0086226; or WO 2019/243631 . . . .

Thermoplastic polymers with the desired number of —NH2 amine and/or —COOH acid functions, or in which the desired number of amine and/or acid functions can be modulated or introduced by plasma treatment, are commercially available.

In the case of polyesters and copolyesters, such polymers are marketed by Evonik Industries AG (Germany), Eastmann Chemical Company (USA), Arkema (France), EMS-Grivory (Switzerland) and Toyobo (Japan).

In the case of polyamide-imides, for example, such polymers are marketed by Solvay (Belgium), Toyobo (Japan) and Mitsubishi Chemical (Switzerland).

In the case of polyethersulfones, such polymers are marketed by BASF (Germany), Sumitomo Chemical (Japan) and Ensinger Plastics (Germany).

In the case of polyimides, such polymers are marketed by companies such as DuPont (USA), Evonik Industries AG (Germany) and Huntsmann Corporation (USA).

In the case of polyetherketones, such polymers are marketed by Arkema (France), Solvay (Belgium), Evonik Industries AG (Germany) and Victrex (UK).

Lastly, in the case of polymethyl methacrylates, such polymers are marketed by Evonik Industries AG (Germany) and Kuraray (Japan).

The reactive thermoplastic polymer in the porous layer can be an amorphous polymer, but is preferably a semi-crystalline polymer. Semi-crystalline polymers have a glass transition temperature below their melting point, which makes them easier to soften and thus easier to bond to the fibrous reinforcement, or to deposit and/or preform the reinforcing material according to the invention. In addition, semi-crystalline polymers in particular have an organized molecular structure in which the chains are aligned, giving them superior mechanical properties to amorphous polymers in which the molecular structure is not organized.

When we talk about the melting temperature of a thermoplastic polymer or porous layer, we're talking about the peak melting temperature measured by Differential Scanning calorimetry (DSC) at a temperature rise of 10° C./min.

By “fibrous reinforcement associated on at least one of its faces with a porous layer”, we mean that the fibrous reinforcement is bonded to at least one porous layer applied to one of its faces. In particular, this bonding is achieved by adhesive bonding, thanks to the hot tackiness of the porous layer due to its thermoplastic nature. It is also possible, particularly in the case of a stack comprising several fibrous reinforcements and several porous layers, for this bond to be completed or replaced by a mechanical bond of the sewing or knitting type, or by any other physical means (needling, etc.).

Reinforcing materials according to the invention can be described as “dry”, as they are intended to be associated with a binder, in particular a thermosetting resin, for the manufacture of a composite part. Also, the mass of the porous layer(s) present in the reinforcing material according to the invention, does not represent more than 10% of the total mass of the reinforcing material, and preferably represents from 0.5 to 10%, and more preferably from 2 to 6% of the total mass of the reinforcing material according to the invention.

More generally, reinforcing materials according to the invention are so-called dry materials, i.e. they are suitable for making composite parts, in association with a resin, in particular a thermosetting epoxy-type resin. A reinforcing material according to the invention comprises a polymeric portion representing at most 10% of the total mass of the reinforcing material, preferably from 0.5 to 10% of the total mass of the reinforcing material, and more preferably from 2 to 6% of the total mass of the reinforcing material. This polymeric portion comprises, or even consists of, the porous thermoplastic layer(s) present in the reinforcing material according to the invention.

In particular, according to the invention, the thermoplastic porous layer(s) present in the reinforcing material consist(s) of one or more reactive thermoplastic polymer(s), in particular chosen from polyesters, copolyesters, polyamide-imides, polyethersulfones, polyimides, polyetherketones, polymethyl methacrylates, aromatic polyethers, polyamides and copolyamides as defined within the context of the invention, and preferably one or more reactive thermoplastic polymer(s) selected from polyamides and copolyamides as defined within the context of the invention.

The term “nonwoven”, which may also be referred to as “veil”, is conventionally taken to mean a set of randomly arranged continuous or short fibers. These nonwovens or veils can, for example, be produced by the drylaid, wetlaid or spunlaid processes, e.g. by extrusion (“Spunbond”), meltblown extrusion (“Meltblown”), fiberized spray applicator (“Meltblown”) or solvent spinning (“Electrospinning”, “Flashspining”, “Forcespinning”), all of which are well known to the person skilled in the art. In particular, the fibers making up the nonwoven can have an average diameter in the range from 0.5 to 70 μm, and preferably from 0.5 to 20 μm. Nonwovens can consist of short fibers or, preferably, continuous fibers. In the case of short-fiber nonwovens, the fibers can be between 1 and 100 mm long, for example. Nonwovens offer random and preferably isotropic coverage.

Advantageously, the nonwoven or nonwovens present in the reinforcing materials according to the invention have a mass per unit area in the range from 0.2 to 20 g/m². The thickness of a nonwoven in the reinforcing materials according to the invention may vary according to the mode of association with the fibrous reinforcement. Preferably, the nonwoven or each of the nonwovens present in the reinforcing materials according to the invention has a thickness of 0.5 to 50 microns after association with the fibrous reinforcement, preferably 3 to 35 microns, when the association is made by applying heat and pressure, to utilize the hot tackiness of the nonwoven. When the association is achieved by mechanical means, such as sewing, knitting or needling, the nonwoven thickness can be greater than 50 microns, particularly in the range from 50 to 200 microns. The characteristics of these nonwovens can be determined according to the methods described in application WO 2010/046609.

By “fibrous reinforcement” we mean a layer of reinforcing fibers, which may be in the form of a fabric or a unidirectional web of reinforcing fibers in particular. Reinforcing fibers are generally glass, carbon, aramid or ceramic fibers, carbon fibers being particularly preferred.

Conventionally, in this field, the term “unidirectional web or layer of reinforcing fibers” refers to a web consisting exclusively or almost exclusively of reinforcing fibers or yarns deposited in the same direction, so as to extend substantially parallel to one another. In the case of a web of reinforcing yarns, the latter extend in general directions which are parallel or substantially parallel. In particular, according to a particular embodiment of the invention, the unidirectional web does not comprise any weft yarn interweaving the reinforcing yarns or fibers, or even a seam whose purpose would be to give cohesion to the unidirectional web prior to its association with another layer, and in particular with a thermoplastic porous layer. In particular, this avoids any undulation within the unidirectional web. A unidirectional web of reinforcing fibers can consist of a single yarn, although it will more often consist of several aligned yarns arranged side by side. The yarns are arranged to provide total or near-total coverage over the entire surface of the web. In this case, in each of the webs making up the intermediate material, the yarns are preferably arranged edge-to-edge, minimizing or even avoiding any gaps or overlaps.

In the unidirectional web, the reinforcing yarn(s) is (are) preferably not associated with a polymeric binder and is (are) therefore described as dry, i.e. it (they) is (are) neither impregnated, coated nor associated with any polymeric binder prior to association with the thermoplastic porous layer(s). The reinforcing fibers are, however, usually characterized by a standard sizing rate of up to 2% by weight. This is particularly suited to the production of composite parts by resin diffusion, using direct processes. In the unidirectional web, the reinforcing yarn(s) can be twisted yarns.

The fibers making up the fibrous reinforcements used in the context of the invention are preferably continuous. The fibrous reinforcements generally consist of several yarns.

In particular, a carbon yarn consists of a set of filaments and generally comprises from 1,000 to 80,000 filaments, advantageously from 12,000 to 24,000 filaments. Particularly preferred within the context of the invention are carbon yarns of 1 to 24 K, e.g. 3K, 6K, 12K or 24K, and preferably 12 and 24K. For example, the carbon yarns present within the fibrous reinforcements used in the context of the invention have a titre of 60 to 3800 Tex, and preferably 400 to 900 tex. A fibrous reinforcement can be made with any type of carbon yarn, for example, High Resistance (HR) yarns whose tensile modulus is between 220 and 241 GPa and whose tensile stress at break is between 3450 and 4830 MPa, Intermediate Modulus (IM) yarns with a tensile modulus of between 290 and 297 GPa and a tensile stress at break of between 3450 and 6200 MPa, and High Modulus (HM) yarns with a tensile modulus of between 345 and 448 GPa and a tensile stress at break of between 3450 and 5520 Pa (according to the ASM Handbook, ISBN 0-87170-703-9, ASM International 2001). If the unidirectional reinforcement web is made of carbon yarns, it can have a grammage in the range from 126 g/m² to 500 g/m², in particular from 126 to 280 g/m².

### Reinforcing Material According to the Invention

The invention can be applied to different types of reinforcement materials: simple reinforcement materials comprising a single fibrous reinforcement intended to be stacked on top of one another, or more complex reinforcement materials comprising several superimposed fibrous reinforcements, which can be used on their own or also in stacked form.

In particular, examples of simple reinforcing materials include those consisting of a unidirectional web of reinforcing fibers corresponding to the fibrous reinforcement, associated on at least one of its faces with a porous thermoplastic layer comprising or consisting of a reactive thermoplastic polymer as provided for within the context of the invention. In order to have a symmetrical material 1 as illustrated in FIG. 1, the fibrous reinforcement, and in particular the unidirectional web 2 of reinforcing fibers 3, is associated on each of its faces with a thermoplastic porous layer 4,5 comprising or consisting of one or more reactive thermoplastic polymers as provided within the context of the invention and the porous layers present on each of the faces of the unidirectional web of reinforcing fibers are, preferably, identical. In the context of the invention, the thermoplastic porous layer comprising or consisting of one or more reactive thermoplastic polymers has a hot tackiness, and the association of the fibrous reinforcement and the thermoplastic porous layer will advantageously be achieved thanks to the hot tackiness of the porous layer. This tackiness results from the thermoplastic nature of the porous layer. Of course, it may also be possible to replace or even complete this association using the hot tackiness of the porous layer, by sewing or knitting, or by any other means of the physical bonding type (needling, etc.).

The reinforcing material can also take the form of a stack of such reinforcing materials, i.e. (CP/R/CP)ₙ with CP denoting a thermoplastic porous layer comprising or consisting of one or more reactive thermoplastic polymers as defined within the context of the invention, and in particular a nonwoven, and R a unidirectional web, with n being an integer greater than or equal to 1. Preferably, all the porous thermoplastic CP layers have the same, or even identical, grammage and/or all the R fibrous reinforcements have the same, or even identical, grammage. It is also possible for the two outer CP layers of the stack to have a grammage equal to twice the grammage of the other, inner CP layers.

Examples of more complex reinforcing materials include those consisting of a stack of unidirectional reinforcing fiber webs oriented in different directions, with at least one porous thermoplastic layer comprising or consisting of one or more reactive thermoplastic polymers as provided for within the context of the invention interposed between two unidirectional reinforcing fiber webs and/or on the surface of the stack. According to a first variant, such a material can consist of a stack corresponding to a sequence (CP/R)ₙ or (CP/R)ₙ/CP with CP designating a porous thermoplastic layer comprising or consisting of a reactive thermoplastic polymer as defined within the context of the invention, R a unidirectional web as described within the context of the invention and n designating an integer, with preferably all CP layers having an identical grammage, or even being identical. In particular, in such stacks, the fibrous reinforcements R are unidirectional webs of reinforcing fibers, and in particular carbon fibers, preferably of identical grammage. Such materials are known as NCFs (non-crimp fabrics). Conventionally for NCFs, unidirectional webs of reinforcing fibers are associated with each other and with the porous thermoplastic layer(s) present, by sewing or knitting. Of course, it may be possible to replace or even complete this association by sewing or knitting, by an adhesion achieved thanks to the hot tackiness of the thermoplastic porous layer, or by any other means of the physical bonding type (needling . . . ).

In particular, in the case of NCFs, the reinforcing material according to the invention is composed of unidirectional webs extending along different orientations chosen from angles 0°, 30°, 45°, 60°, 90°, 120°, 135°. All or some of the unidirectional webs may have different orientations. By way of example, the reinforcing material according to the invention can be produced in the following stacks: 0°/90°, 90°/0°, 45°/135°, 135/45°, 90°/0°/90°, 0°/90°/0°, 135°/45°/135°, 45°/135°/45°, 0°/45°/90°, 90°/45°/0°, 45°/0°/90°, 90°/0°/45°, 0°/135°/90°, 90°/135°/0°, 135°/0°/90°, 90°/0°/135°, 45°/0°/135°, 135°/0°/45°, 45°/135°/0°, 0°/135°/45°, 45°/135°/90°, 90°/135°/45°, 135°/45°/0°, 0°/45°/135°, 135°/45°/90°, 90°/45°/135°, 60°/0°/120°, 120°/0°/60°, 30°/0°/150°, 150°/0°/30°, 135°/0°/45°/90°, 90°/45°/0°/135°, 45°/135°/0°/90°, 90°/0°/135°/45°, 0°/45°/135°/90°, 90°/135°/45°/90°, 90°/135°/0°/45°, 45°/0°/135°/90°, with 0° corresponding to the machine feed direction for producing the reinforcing material according to the invention. In the case of association by sewing or knitting, the general direction of the sewing or knitting yarns will also generally correspond to 0°. The production of such multiaxials is well known and involves conventional techniques, for example as described in the book “Textile Structural Composites, Composite Materials Series Volume 3” by Tsu Wei Chou & Franck.K.Ko, ISBN 0-444-42992-1, Elsevier Science Publishers B.V., 1989, Chapter 5, paragraph 3.3 or in patent FR2761380, which describes a process and a device for producing multiaxial fibrous webs. In particular, the unidirectional webs can be formed before, or deposited in-line, when the multiaxial is created. The unidirectional webs can be sewn or knitted together using stitches running parallel to one another. In particular, the sewing or knitting stitches are spaced within the same line at a pitch, preferably identical, of 1 to 20 mm, more preferably 2 to 12 mm. Similarly, two consecutive sewing or knitting lines are, for example, spaced apart by 2 to 50 mm, preferably 5 to 15 mm. Preferably, all consecutive sewing lines in a series of parallel lines will be spaced at the same distance apart. Polyesters, copolyesters, polypropylenes (PP), polyethylenes (PE), polyphenylene sulfides (PPS), polyethylene naphthalates (PEN), liquid crystal polymers (LCP), polyketones, polyamides, cross-linkable thermoplastics, carbon, glass, basalt, silica and mixtures thereof are examples of sewing yarn materials particularly suited within the context of the invention. Polyethylene terephthalate, polybutylene terephthalate, polytrimethylene terephthalate, polylactic acid and their copolymers are examples of polyesters that can be used. The yarn will, for example, have a titre in the range from 5 to 150 dTex, in particular less than 30 dTex, for example determined in accordance with standard EN ISO 2060. For more details on the constructions that can be used in NCF-type materials, please refer to documents such as EP 2547816 or WO 2010/067003.

Whatever the arrangement of the reinforcing materials according to the invention, according to particular embodiments, the said thermoplastic porous layer(s) present comprise(s) —NH₂ functions in an amount greater than 0.15 meq/g of porous layer and/or —COOH functions in an amount greater than 0.20 meq/g of porous layer. In particular, the said thermoplastic porous layer(s) present comprise(s) free —COOH functions, in an amount greater than 0.20 meq/g thermoplastic porous layer, in particular in an amount greater than or equal to 0.22; 0.25; 0.30 or 0.40 meq/g thermoplastic porous layer; preferably in the range from 0.20 to 1 meq/g thermoplastic porous layer and more preferably in the range from 0.20 to 0.95 meq/g thermoplastic porous layer, especially in the range from 0.20 to 0.60 meq/g thermoplastic porous layer, in the range from 0.20 to 0.50 meq/g thermoplastic porous layer, or, even more preferably, in the range from 0.22 to 0.46 meq/g thermoplastic porous layer. In particular, the said thermoplastic porous layer(s) present comprise(s) free —NH2 functions, in an amount greater than 0.20 meq/g thermoplastic porous layer, particularly in an amount greater than or equal to 0.25; 0.30 or 0.34 meq/g thermoplastic porous layer; preferably in the range from 0.20 to 1 meq/g thermoplastic porous layer and more preferably in the range from 0.20 to 0.95 meq/g thermoplastic porous layer, in particular in the range from 0.20 to 0.60 meq/g thermoplastic porous layer; in the range from 0.30 to 0.50 meq/g thermoplastic porous layer, in the range from 0.30 to 0.40 meq/g thermoplastic porous layer, or, even more preferably, in the range from 0.32 to 0.36 meq/g thermoplastic porous layer. The said quantities of —COOH or —NH2 functions can be present alone or together, in any possible combination, on a thermoplastic porous layer.

### Process for Preparing a Reinforcing Material According to the Invention

In the context of the invention, a reinforcing material according to the invention can be prepared by carrying out the following successive steps:

a1) providing a fibrous reinforcement,
a2) providing at least one thermoplastic porous layer comprising or consisting of a reactive thermoplastic polymer as defined within the context of the invention,
a3) associating the fibrous reinforcement and the at least one thermoplastic porous layer.

In particular, step a3) may be achieved by applying at least one thermoplastic porous layer to the fibrous reinforcement, said application most often being accompanied or followed by heating causing softening or melting of said reactive thermoplastic polymer of said at least one thermoplastic porous layer, then followed by cooling. In particular, such an association can be achieved at a temperature of 22 to 200° C., preferably 50 to 180° C., and is carried out under ambient air, and by applying the thermoplastic porous layer to the fibrous reinforcement, for example, by exerting pressure on the latter. Advantageously, said reactive thermoplastic polymer of said thermoplastic porous layer(s) present within the reinforcing material has a melting temperature below 170° C., or even 150° C. and preferably is in the range from 100 to 140° C., and more preferably in the range from 100 to 130° C. In particular, said thermoplastic porous layer(s) present has (have) a melting temperature which is lower than 170° C., or even 150° C. and preferably is in the range from 100 to 140° C., and more preferably in the range from 100 to 130° C. With such reactive thermoplastic polymers, the association of the thermoplastic porous layer and the fibrous reinforcement using the hot tackiness of the thermoplastic porous layer can be achieved by heating to a temperature below 170° C., or even 150° C. and preferably is in the range from 100 to 140° C., and more preferably in the range from 100 to 130° C.

Step a3) can also be carried out by sewing, knitting, needling or any other suitable means for bonding the fibrous reinforcement and the thermoplastic porous layer together.

In particular, when the fibrous reinforcement according to the invention corresponds to a stack of unidirectional webs of reinforcing yarns bonded together by sewing or any other physical means, in particular of the needling type, step a1) consists in providing several fibrous reinforcements which are unidirectional webs of reinforcing yarns, step a3), during which the said fibrous reinforcements and the at least one thermoplastic porous layer are associated, comprises the creation of a stack of unidirectional webs of reinforcing yarns and the said at least one thermoplastic porous layer, and producing a stack of unidirectional webs of reinforcing yarns bonded together by sewing or any other physical means, in particular of the needling type. Step can comprise both an association achieved by sewing, knitting, needling or any other suitable means enabling the fibrous reinforcement and the thermoplastic porous layer to be bonded together, and an association achieved by applying the at least one thermoplastic porous layer to at least one of the unidirectional webs of reinforcing yarns, said application usually being accompanied or followed by heating to soften or melt said reactive thermoplastic polymer of said at least one porous thermoplastic layer, said heating being followed by cooling. In the case of more complex materials comprising at least one thermoplastic porous layer comprising or consisting of one or more reactive thermoplastic polymers as provided for within the context of the invention, between two fibrous reinforcements, and in particular, in the case of NCFs, the process will comprise making a stack of the various layers, and in particular according to a sequence (CP/R)ₙ or (CP/R)ₙ/CP, as previously defined, with n greater than 1 and the association of the different layers with each other may be completed or achieved by a sewing, knitting, needling or other mechanical assembly operation.

Of course, whatever the preparation process used, the porous layer and the reinforcing material will be chosen so that, in the end, the thermoplastic porous layer(s) represent(s) at most 10% of the total mass of the reinforcing material, preferably from 0.5 to 10% of the total mass of the reinforcing material, and more preferably from 2 to 6% of the total mass of the reinforcing material obtained.

The characteristics of the process are related to the characteristics of the reinforcement materials as described within the context of the invention.

### Use and Process Using a Reinforcing Material According to the Invention for the Manufacture of a Preform or a Composite Part

The reinforcing materials of the invention comprise a fibrous reinforcement associated on at least one of its faces with a thermoplastic porous layer comprising a reactive thermoplastic polymer as defined within the context of the invention, in particular chosen from polyesters, copolyesters, polyamide-imides, polyethersulfones, polyimides, polyetherketones, polymethyl methacrylates, aromatic polyethers, polyamides and copolyamides, which carry —NH2 functions in a quantity greater than 0.15 meq/g of reactive thermoplastic polymer and/or —COOH functions in a quantity greater than 0.20 meq/g of reactive thermoplastic polymer, are perfectly suited to the production of a preform or composite part, in association with an epoxy thermosetting resin.

The resin diffused or injected into the reinforcing material or a stack of reinforcing materials according to the invention is a thermosetting epoxy resin. Examples of epoxy resins include polyglycidyl derivatives of aromatic diamines, mono-aromatic primary amines, aminophenols and polycarboxylic acids. Other examples include polyglycidyl ethers of bisphenols such as bisphenol A, bisphenol F, bisphenol S and bisphenol K. Numerous epoxy resins suitable for the direct production of composite parts are commercially available, in particular from Solvay, Hexion and Hexcel Composites. Examples include RTM6 and HF620 resins from Hexcel Composites, and EP2400 and EP2410 resins from Solvay. These resins are composed of a mixture of epoxy resins, associated with a mixture of one or more curing agents and optionally one or more impact modifiers.

Other commercially available epoxy resins include N,N,N′,N′-tetraglycidil diamino diphenylmethane (Huntsman MY9663, MY720, MY721), p-aminophenol triglycidyl ethers (such as Huntsman's MY0510), m-aminophenol triglycidyl ethers (such as Huntsman's MY0600) or bifunctional epoxides (such as Huntsman's GY285 and CY184).

Epoxy thermosetting resins can be tetra-, tri- or bifunctional, with an increase in the number of epoxy functionalities naturally leading to higher crosslinking reaction kinetics. Such an epoxy thermosetting resin conventionally comprises one or more curing agents, well known to the person skilled in the art for use with the selected epoxy-type thermosetting polymers. Examples of preferred curing agents include cyanoguanidines, aromatic, aliphatic and alicyclic amines, acid anhydrides, Lewis acids, substituted ureas, imidazoles, hydrazines and silicones. An epoxy resin may also include a core-shell impact modifier or toughener, as is conventional for the person skilled in the art. Examples include Kane Ace MX impact modifiers from Kaneka (Japan), or Clearstrength impact modifiers from Arkema France. The process according to the invention is of particular interest when the injected or infused resin is a thermosetting resin of the epoxy type. Epoxy resins have the ability to react with the —NH2 or —COOH functions present in sufficient quantity in the porous thermoplastic layers of the materials according to the invention. Such a reaction prevents the thermoplastic polymer in the porous layer(s) from spreading into the injected or infused resin and altering the latter's properties, particularly in terms of heat resistance.

Preferably, an epoxy resin is used in the context of the invention comprising a tetrafunctional epoxy, optionally mixed with a trifunctional epoxy, one or more curing agents and one or more impact modifiers.

Advantageously, the thermosetting epoxy resins used in the context of the invention have a Tg of 100° C. or more, or even more than 150° C. The choice of Tg of the resin used can be adapted by the person skilled in the art, depending on the process steps implemented and whether he wishes to heat at a temperature Ta below or above the melting temperature of the reactive thermoplastic polymer.

Conventionally, composite parts are produced in an open or closed mold. Before being introduced into the mold, the resin can be preheated. In particular, before infusion or injection into the reinforcing material, stack or preform, the resin can be preheated to a temperature of 60-90° C.

The injected or infused resin preferably has a viscosity of less than 1000 mPa·s at the temperature at which the resin is introduced into the mold. Preferably, the thermosetting resin used has a viscosity of less than 1000 mPa·s at a temperature of 90° C. In general, when manufacturing composite parts, the temperature at which a thermosetting resin is infused or injected into the mold varies most often between 9° and 180° C. In the context of the invention, viscosity can be measured with a dynamic shear rheometer in accordance with standard EN6043, with the difference that the deformation is 4% and not 10%. In particular, the measurement is carried out with an air gap of 0.5 mm, deformation control at 4% and a frequency of 10 rad/s, the heating rate for an isotherm being 2° C./min.

Conventionally, in a process for manufacturing a preform or composite part from at least one reinforcing material according to the invention, a thermosetting, thermoplastic resin or a mixture of thermosetting and thermoplastic resins, and in particular a thermosetting epoxy resin, in particular as defined within the context of the invention, is injected or infused into said reinforcing material, or into a stack of several reinforcing materials, or into a preform made from said material. By preform we mean a reinforcing material, or a set of reinforcing materials, which has undergone a prior shaping operation, before being placed in the mold or tool used to make the composite part.

To produce composite parts, reinforcing materials according to the invention are stacked or draped (also known as plies). Conventionally, a reinforcing material according to the invention is cut to the desired size to produce the part, ply, stack or preform to be manufactured. In a stack, several reinforcing materials or plies are stacked on top of each other.

A ply can consist of a single reinforcing material according to the invention when it is wide enough to produce the desired part and the part is not very complex. More often, however, in the case of large or complex parts, a ply consists of a set of reinforcing materials according to the invention, arranged side by side to cover the entire surface required to produce the desired part.

In the context of the invention, due to the thermoplastic nature of the porous layer present in the reinforcing material, prior to the infusion or injection of the resin, a deposition or shaping operation using the hot tackiness of the said at least one porous layer present in the reinforcing material can be carried out during the production of the preform or composite part. Advantageously, the processes for manufacturing a preform or composite part comprise a step of depositing or shaping a material according to the invention, in which, the porous layer is heated to a temperature causing at least partial melting of said reactive thermoplastic polymer of the porous layer(s) defined within the context of the invention, and in particular to a temperature below 170° C., or even 150° C., and preferably is in the range from 100 to 140° C., and more preferably in the range from 100 to 130° C.

The steps used to manufacture the composite part are quite conventional for the person skilled in the art. A flat preform or even a preform with a desired three-dimensional shape can be produced in between. In particular, the deposition of a reinforcing material according to the invention can be carried out continuously with the application of pressure perpendicular to the deposition surface, in order to apply it to the latter. Such processes, known by the abbreviations AFP (Automated Fiber Placement) or ATL (Automated Tape Lay-up) are, for example, described in documents WO 2014/076433 A1 and WO 2014/191667. Different strips of material according to the invention can be laid next to one another along parallel or non-parallel deposition paths, depending on the preform to be produced, so as to form a succession of plies laid one on top of the other. Concurrently with the depositing operation, the thermoplastic material of the porous layer is activated, i.e. softened, so as to make use of the material's hot tackiness. When a ply is fully deposited, the orientation is changed, so that the next ply is deposited along a different depositing trajectory to the previous ply. Each strip is deposited parallel or not (depending on the geometry of the part to be produced) to the previous strip, with or without an inter-strip gap and with bonding over the entire surface. This deposition process is particularly suitable for reinforcement material widths of between 3 and 300 mm, preferably with small width variations (<0.25 mm). If the reinforcing material has a wider width, it can be deposited by any other suitable means.

In general, the manufacture of a composite part from at least one reinforcing material comprising at least one fibrous reinforcement associated on at least one of its faces with a thermoplastic porous layer and a resin corresponding to a thermosetting resin of the epoxy type comprises the following successive steps:
i) injection or infusion, at a temperature typically ranging from 90 to 180° C., of said resin into said reinforcing material placed inside the mold;
ii) consolidation of the reinforcing material/resin assembly in a heat treatment cycle;
iii) cooling of the consolidated composite part resulting from step ii).

Conventionally, upstream of step i), the process for manufacturing a composite part according to the invention comprises a step of arranging inside a mold at least one reinforcing material comprising at least one fibrous reinforcement associated on at least one of its faces with a thermoplastic porous layer according to the invention.

Thus, the manufacture of the composite part involves a step of diffusion, by infusion or injection, of a thermosetting, thermoplastic resin or a mixture of thermosetting and thermoplastic resins within the reinforcing material or a stack of reinforcing materials according to the invention, followed by a step of consolidation of the desired part by a polymerization/crosslinking step following a defined cycle in temperature and optionally under pressure, and a cooling step. According to a particular embodiment, which is also suitable for all the implementation variants described in connection with the invention, the diffusion or injection, consolidation and cooling steps are carried out in an open or closed mold.

As mentioned above, in the context of the invention, and in a very particularly preferred way, the resin injected or infused is an epoxy resin.

For step i), the temperature referred to is the temperature inside the mold when the resin is injected or diffused into the reinforcing material.

Resin injection or infusion is usually carried out while the reinforcement material, stack or preform within which the resin is injected or infused is at a temperature of 110 to 180° C. This injection or infusion stage usually lasts between 2 minutes and 5 hours, depending on the size of the composite part to be produced.

In order to produce the composite part, the resin is preferably infused under reduced pressure, in particular at a pressure below atmospheric pressure, in particular below 1 bar and preferably between 0.1 and 1 bar. Infusion is preferably carried out in an open mold (especially one fitted with a vacuum bag), for example by vacuum bag infusion. During the heat treatment stage, a pressure lower than atmospheric pressure, in particular less than 1 bar and preferably between 0.1 and 1 bar, can also be applied.

In other processes according to the invention, the resin is added by injection and the reinforcing material according to the invention, the stack of such materials or the preform placed in a mold intended to be closed (conventionally called a closed mold), in particular once the resin has been injected in sufficient quantity to fill the mold. In such cases, where the resin is injected, the heat treatment step is carried out under pressure in the conventional way, in particular at a pressure of 1 to 150 bar, and preferably 1 to 10 bar. This is the case with the RTM, C-RTM and HP-RTM processes, which are well known to the person skilled in the art.

The composite part is then obtained after a consolidation step corresponding to a heat treatment. Step ii) is a heat treatment step for the resin/reinforcement material(s) assembly, leading to cross-linking of the thermosetting resin and consolidation of the composite part. This step involves heating to a temperature Ta, conventionally referred to as the composite part's curing temperature. This temperature Ta may be equal to that of step i) or higher. In such a case, where it is higher than the resin infusion or injection temperature, step ii) comprises a temperature rise phase, up to temperature Ta.

The composite part is generally obtained by a conventional consolidation step involving heating, using a heat treatment cycle recommended by the supplier of the resin used, and according to a practice known to the person skilled in the art. This step of consolidating the desired part involves polymerization (in the case of a thermoplastic resin) or cross-linking (in the case of a thermosetting resin). In the case of a thermosetting resin, gelling of the resin takes place before curing/crosslinking. The pressure applied during the processing cycle is low in the case of infusion under atmospheric or reduced pressure (and in particular from 0.1 mbar to 1 bar) and higher in the case of injection into an RTM mold (and in particular from 1 to 150 bar). In general, epoxy resin is added at a pressure of 0.1 mbar to 15 bar, more conventionally 1 to 10 bar.

Most often, during the heat treatment step, also known as the consolidation step, the heat treatment cycle comprises two phases: a temperature rise phase up to a temperature Ta and a heating step at said temperature Ta, generally known as the curing or post-curing step. The temperature Ta is a temperature at which the thermosetting resin is crosslinkable. The temperature Ta and the heating time at this temperature are selected to achieve complete cross-linking of the selected epoxy thermosetting resin. In particular, temperature Ta is a function of the resin injected or infused. In general, the temperature Ta is in the range from 120 to 220° C., preferably 160 to 220° C., more preferably 170 to 190° C., and typically 180° C., especially for epoxy resins used to make composite parts for the aerospace industry. The heating time at such temperatures is usually 30 minutes to 5 hours, typically 1 to 2 hours. The heating time will be adapted, by the person skilled in the art, to the temperature Ta. The lower the temperature Ta, the longer the heating time required to fully cure the resin.

Conventionally, the temperature is increased by 0.1 to 10° C. per minute, and in particular by 1 to 3° C. per minute, typically 2° C. per minute.

According to a first implementation variant, the heat treatment step comprises a temperature rise phase, in particular at a rate of 0.1 to 10° C./minute, up to a temperature Ta, which is higher than the melting temperature of said reactive thermoplastic polymer of said at least one thermoplastic porous layer present in the reinforcing material according to the invention and heating at said temperature Ta, in particular for 5 minutes to 2 hours. The viscosity of the thermosetting resin (or more strictly the thermosetting resin system modified following reaction with the thermoplastic porous layer) increases between melting of said reactive thermoplastic polymer of the thermoplastic porous layer(s) and initiation of crosslinking of the epoxy thermosetting resin. This increase in viscosity reflects the reactions taking place between the epoxy resin and the reactive —NH2 and/or —COOH functions of the reactive thermoplastic polymer in the porous thermoplastic layer of the reinforcing material.

The reaction between the epoxy resin and the reactive —NH2 and/or —COOH functions of the reactive thermoplastic polymer in the porous thermoplastic layer of the reinforcing material can also have the effect that, during the heat treatment step, gelling of the epoxy thermosetting resin occurs earlier than if the latter were subjected to the heat treatment step alone.

According to particular embodiments, gelling of the thermosetting resin takes place during heating to temperature Ta, after a heating time of 5 minutes to 60 minutes at temperature Ta. The time at which the epoxy resin gels will depend in particular on the reactivity of the epoxy resin, the injection/infusion temperature of the epoxy resin, the rate of temperature rise Ta and the selected temperature Ta.

According to the first variant of the manufacturing process of a composite part according to the invention where the temperature Ta is higher than the melting temperature of said reactive thermoplastic polymer of said at least one thermoplastic porous layer, the epoxy thermosetting resin has, preferably, a glass transition temperature Tg higher than 150° C.

According to a second implementation variant, the heat treatment step comprises a temperature rise phase, in particular at a rate of 0.1 to 10° C./minute up to a temperature Ta, which is lower than the melting temperature of said reactive thermoplastic polymer of said at least one thermoplastic porous layer, and heating at said temperature Ta, in particular for 5 minutes to 5 hours. In this case, where heating to achieve complete cross-linking/polymerization of the epoxy resin is carried out at a lower temperature Ta, the heating time at this temperature may be longer. This will be adjusted by the person skilled in the art according to the resin used. Here again, the reaction between the epoxy resin and the reactive —NH2 and/or —COOH functions of the reactive thermoplastic polymer of the porous thermoplastic layer of the reinforcing material may also have the effect that, during the heat treatment step, gelling of the epoxy thermosetting resin occurs earlier than if the latter were subjected to the heat treatment step alone.

According to the second variant of the manufacturing process of a composite part according to the invention where the temperature Ta is lower than the melting temperature of said reactive thermoplastic polymer of said at least one thermoplastic porous layer, the epoxy thermosetting resin has, preferably, a glass transition temperature Tg at least equal to 100° C., and advantageously in the range from 100 to 150° C.

Also advantageously, according to the second variant of the manufacturing process of a composite part according to the invention where the temperature Ta is lower than the melting temperature of said reactive thermoplastic polymer of said at least one thermoplastic porous layer, said reactive thermoplastic polymer has a melting temperature higher than 120° C.

In the context of the invention, and irrespective of how the process is implemented, during the heat treatment stage, gelling of the thermosetting resin takes place after reactive functions of the reactive thermoplastic polymer of the porous thermoplastic layer of the reinforcing material have reacted with the epoxy thermosetting resin. On the other hand, other reactions may still occur during the complete crosslinking of the resin.

Once heat treatment has been completed, cooling is carried out by circulating a fluid acting as a coolant, in particular water or a mixture of water and air, while heating is interrupted. Pressurization is usually interrupted during cooling, particularly when a temperature below 40° C. is reached.

Of course, the same characteristics and applications described in connection with the reinforcing material according to the invention apply to the processes and uses described within the context of the invention.

The reactive thermoplastic polymer used in the context of the invention carries a sufficient quantity of reactive —NH2 and/or —COOH functions to enable it to react with epoxy-type resins conventionally used in the manufacture of composite parts. As will become apparent from the examples, such a reaction will make it possible to impart particularly advantageous characteristics to the composite parts obtained, in particular to improve temperature and moisture resistance properties, while retaining satisfactory mechanical properties of importance for composite parts intended for the aeronautics and aerospace industries.

### OTHER ASPECTS OF OTHER INVENTIONS

The present invention can be applied to thermosetting resins other than those of the epoxy family.

Other usable thermosetting resins are, in particular, selected from unsaturated polyesters, vinylesters, phenolic resins, polyimides, bismaleimides, phenol-formaldehyde resins, urea-formaldehyde resins, 1,3,5-triazine-2,4,6-triamines, benzoxazines, cyanate esters, and mixtures thereof. Such a resin may also comprise one or more curing agents, well known to the person skilled in the art for use with the selected thermosetting polymers.

The reactive functions present on the reactive polymer will then be adapted by the person skilled in the art to react with the injected or infused thermosetting resin. In particular, in the case of unsaturated polyester or vinyl ester resins, as well as bismaleimides, the reactive thermoplastic polymer may contain unsaturations enabling it to react with these resins.

In the case of phenolic resins, the reactive thermoplastic polymer may, for example, contain alcohol, aldehyde or ketone functions enabling it to react with this type of resin.

The descriptions given above for the use of epoxy resins can be transposed to these types of processes.

Thus, the present description also relates to the following aspects.

The description relates to a process for manufacturing a composite part comprising the following successive steps:
0) a step of arranging inside a mold at least one reinforcing material comprising at least one fibrous reinforcement associated on at least one of its faces with a thermoplastic porous layer;
i) a step of injecting or infusing a thermosetting resin, at a temperature which can range in particular from 90 to 180° C., within said reinforcing material placed inside the mold;
ii) a heat treatment step for the resin/reinforcement material(s) assembly, comprising heating to a temperature Ta, leading to cross-linking of the thermosetting resin and consolidation of the composite part;
iii) cooling of the consolidated composite part resulting from step ii);
characterized in that said thermoplastic porous layer carries reactive functions which react with the thermosetting resin during the heat treatment step.

In particular, in such a process, said thermoplastic porous layer(s) of said reinforcing material represent at most 10% of the total mass of the reinforcing material, preferably from 0.5 to 10% of the total mass of the reinforcing material, and more preferably from 2 to 6% of the total mass of the reinforcing material.

In such a process, the porous layer present in the reinforcing material reacts with the thermosetting resin, making the latter only partially meltable, or even totally unmeltable, in the thermosetting resins, particularly of the epoxy type, which are commonly used in the manufacture of composite parts. As part of the process according to the invention, the thermoplastic porous layer carries reactive functions which react with the thermosetting resin during the heat treatment stage, thereby reducing sensitivity to temperature exposure and improving temperature properties for materials used in the aerospace industry.

According to a first variant of such a composite part manufacturing process, said temperature Ta is higher than the melting temperature of said reactive thermoplastic polymer of said at least one thermoplastic porous layer. In particular, heating to said temperature Ta is carried out during step ii) for 5 minutes to 2 hours. Most often, the heat treatment step comprises a temperature rise phase, in particular at a rate of 0.1 to 10° C./minute, up to said temperature Ta.

It is possible that the viscosity of the thermosetting resin increases between the melting of said reactive thermoplastic polymer of the thermoplastic porous layer and the initiation of the crosslinking of the thermosetting resin. In particular, the viscosity of the modified thermosetting resin system following melting and reaction with the thermoplastic porous layer increases.

It is also possible that, during the heat treatment step, gelling of the thermosetting resin occurs earlier than if the latter were subjected to the heat treatment step alone.

Gelling of the thermosetting resin may occur during heating to temperature Ta, in particular after a heating time of 5 minutes to 60 minutes at temperature Ta.

According to the first variant of such a process for manufacturing a composite part where the temperature Ta is higher than the melting temperature of said reactive thermoplastic polymer of said at least one thermoplastic porous layer, the thermosetting resin preferably has a glass transition temperature Tg higher than 150° C.

According to a second variant of such a composite part manufacturing process, the temperature Ta is lower than the melting temperature of said reactive thermoplastic polymer of said thermoplastic porous layer. In particular, heating to said temperature Ta, for 5 minutes to 5 hours, is carried out during step ii). Preferably, gelling of the thermosetting resin occurs earlier than if the latter were subjected to the heat treatment step alone. Here again, the heat treatment step generally comprises a temperature rise phase, in particular at a rate of 0.1 to 10° C./minute, up to said temperature Ta.

According to the second variant of such a process for manufacturing a composite part, where the temperature Ta is lower than the melting temperature of said reactive thermoplastic polymer of said at least one thermoplastic porous layer, the thermosetting resin preferably has a glass transition temperature Tg at least equal to 100° C., and advantageously in the range from 100 to 150° C.

Also advantageously, according to the second variant of such a process for manufacturing a composite part where the temperature Ta is lower than the melting temperature of said reactive thermoplastic polymer of said at least one thermoplastic porous layer, said reactive thermoplastic polymer has a melting temperature higher than 120° C.

In such processes for manufacturing a composite part, whatever their variant of implementation, the temperature Ta is, in general, in the range from 120 to 220° C., preferably is in the range from 160 to 220° C., more preferably in the range from 170 to 190° C., and is typically equal to 180° C.

In said processes for manufacturing a composite part, whatever their implementation variant, during the heat treatment step, advantageously, gelling of the thermosetting resin occurs after reactive functions have reacted with said thermosetting resin.

Furthermore, the reaction of the thermoplastic polymer of the porous layer with the injected or infused resin will enable the use of a porous layer with a low melting temperature, and thus enable the use of a low temperature during manufacture and also during shaping of the reinforcement material, and thus a saving in terms of cost and time. A further advantage is that the melting temperature of said reactive thermoplastic polymer of the thermoplastic porous layer can be lower than 170° C., or even 150° C., thus enabling all the stages of the manufacturing process prior to the addition of the resin ultimately required to produce the part (from preparation of the dry material, through its deposition and preforming) to be carried out at a temperature lower than 170° C., and even better lower than 150° C. or even less. Thus, such porous layers comprising a reactive thermoplastic polymer with a lower melting point will enable the reinforcing material associating porous layer(s) and fibrous reinforcement(s) to be manufactured at a temperature compatible with automated manufacturing processes, in particular fiber placement and hot forming of flat-laid preforms.

The secondary aim of such processes is therefore to combine the beneficial effects of using a thermoplastic porous layer on impact resistance performance, with the possibility of carrying out all the stages of the manufacturing process prior to resin infusion or injection, at temperatures below 150° C. or even 140° C., and in some cases in the range 80 to 130° C. or 100 to 130° C.

Thus, advantageously, in said process of manufacturing a composite part, said reactive thermoplastic polymer of said at least one thermoplastic porous layer present within the reinforcing material has a melting temperature lower than 170° C., or even 150° C. and preferably is in the range from 100 to 140° C., and more preferably in the range from 100 to 130° C.

Prior to infusion or injection of the said thermosetting resin, the said processes for manufacturing a composite part may comprise deposition or shaping of the said reinforcing material(s), which makes use of the hot tackiness of the said at least one thermoplastic porous layer present in the said reinforcing material(s), and involves heating to a temperature below 170° C., or even 150° C., preferably in the range from 80 to 140° C., especially 100 to 140° C., and more preferably in the range from 80 to 130° C., especially 100 to 130° C., selected as a function of the melting temperature of said reactive thermoplastic polymer of said thermoplastic porous layer.

These methods of manufacturing a composite part are particularly suited to cases where the injected or infused resin is an epoxy resin.

Advantageously, said epoxy resin has a viscosity of less than 1000 mPa·s at a temperature of 90° C.

Particularly preferred epoxy resins include those comprising a tetrafunctional epoxy, optionally mixed with a trifunctional epoxy, one or more curing agents and one or more impact modifiers.

In particular, in said processes for manufacturing a composite part, the thermoplastic porous layer comprises a so-called reactive thermoplastic polymer or consists of one or more reactive thermoplastic polymers, a reactive thermoplastic polymer carrying —NH₂ functions in a quantity greater than 0.15 meq/g of reactive thermoplastic polymer and/or carrying —COOH functions in a quantity greater than 0.20 meq/g of reactive thermoplastic polymer. Such porous thermoplastic layers are particularly suitable when the injected or infused resin is an epoxy resin, in particular one of the resins described above.

Advantageously, said reactive thermoplastic polymer carries —NH₂ functions in an amount greater than 0.20 meq/g of reactive thermoplastic polymer, preferably in the range from 0.20 to 1 meq/g of reactive thermoplastic polymer and more preferably in the range from 0.20 to 0.95 meq/g of reactive thermoplastic polymer, and/or carries-COOH functions in an amount greater than 0.20 meq/g of reactive thermoplastic polymer, preferably in the range from 0.20 to 1 meq/g of reactive thermoplastic polymer and more preferably in the range from 0.20 to 0.95 meq/g of reactive thermoplastic polymer.

In particular, the reactive thermoplastic polymer is a polyamide or copolyamide carrying said functions.

In particular, in said processes for manufacturing a composite part, said at least one porous layer comprises —NH₂ functions in a quantity greater than 0.15 meq/g of porous layer and/or —COOH functions in a quantity greater than 0.20 meq/g of porous layer. Here again, such thermoplastic porous layers are particularly suited to the case where the injected or infused resin is an epoxy resin, in particular one of the resins previously described.

According to particular embodiments, the reactive thermoplastic polymer has a number-average molecular weight Mn greater than 4000 g/mol.

According to particular embodiments, step i) is carried out by resin injection and the heat treatment of step iii) is carried out under a pressure of 1 to 150 bar in a closed mold.

According to other particular embodiments, arrangement step 0) is carried out in an open mold, in particular fitted with a vacuum cover, and step i) is carried out under reduced pressure, in particular under a pressure of between 0.1 and 1 bar.

In the reinforcement materials used in such processes, the fibrous reinforcement can take different forms. In some embodiments, the fibrous reinforcement is a unidirectional web of reinforcing yarns, a fabric of reinforcing yarns or a stack of unidirectional webs of reinforcing yarns bonded together by sewing or any other physical means, such as needling.

The fibrous reinforcement can, in particular, consist of glass fibers, aramid fibers or, preferably, carbon fibers.

According to some embodiments of such processes, a reinforcing material used consists of a unidirectional web of reinforcing yarns corresponding to the fibrous reinforcement, associated on at least one of its faces with a thermoplastic porous layer as defined within the context of the invention, preferably said reinforcing material consisting of a unidirectional web of reinforcing yarns corresponding to the fibrous reinforcement, associated on each of its faces with a thermoplastic porous layer as defined within the context of the invention, and the thermoplastic porous layers present on each of the faces of the unidirectional web of reinforcing yarns being identical.

According to some embodiments, a reinforcing material used in said processes consists of a stack of unidirectional webs of reinforcing yarns, as fibrous reinforcements, oriented in different directions, with at least one thermoplastic porous layer as defined within the context of the invention, interposed between two unidirectional webs of reinforcing yarns and/or on the surface of the stack. Such a stack may consist of a superposition of layers corresponding to a sequence (CP/R)ₙ (CP)ₘ or (CP/R/CP)ₙ with CP designating a porous thermoplastic layer as defined within the context of the invention, R a unidirectional web, n an integer greater than or equal to 1 and m equal to 0 or 1. In such stacks, the unidirectional webs of reinforcing yarns can be associated with each other, or associated with the at least one thermoplastic porous layer, by sewing, knitting or needling.

In the reinforcing materials used in the said processes, the said thermoplastic porous layer(s) present is (are), in particular, a porous film, a grid, a powder deposit, a fabric or, preferably, a non-woven or veil.

Another aspect of the description also relates to composite parts obtained by a manufacturing process as defined herein.

The present description therefore relates to composite parts which comprise a thermoset, and in particular epoxy, matrix in which is included at least one reinforcing material comprising at least one fibrous reinforcement associated on at least one of its faces with a thermoplastic porous layer. In said composite parts, covalent bonds exist between the thermoset epoxy matrix and the thermoplastic polymer present within the thermoplastic porous layer(s), said covalent bonds resulting from the reaction of reactive functions that were present on said thermoplastic polymer and the thermosetting resin, and in particular epoxy. In particular, in such composite parts, said thermoplastic porous layer(s) of said reinforcing material represent at most 10% of the total mass of the reinforcing material, preferably from 0.5 to 10% of the total mass of the reinforcing material, and more preferably from 2 to 6% of the total mass of the reinforcing material.

The following examples, with reference to the appended Figures, illustrate the invention, but are not intended to be limiting.

### BRIEF DESCRIPTION OF THE FIGURES

FIG. 1 is a schematic view of a manufacturing process for an example of reinforcing material according to the invention.

FIG. 2 is a schematic view of an example of a reinforcing material according to the invention.

FIG. 3 shows images obtained under optical microscopy, when different veils and RTM6 epoxy resin are placed between two glass slides and subjected to 180° C. heating.

FIG. 4 shows the reversible and non-reversible heat flows following a temperature rise of 2° C./min, by modulated differential scanning calorimetry, of different veils in a Huntsman tetrafunctional epoxy resin, which does not include hardener, after a cycle of 1 h 120° C.+2 h 180° C. with a temperature rise of 2° C./min.

FIG. 5 shows the evolution of the viscosity of RTM6 resin alone during curing, of RTM6 resin when diffused within a stack of CP1 porous layers conforming to the invention, and of the same stack of CP1 porous layers in oil.

FIG. 6 shows the evolution of the viscosity of RTM6 resin alone (temperature rise followed by curing), and of RTM6 resin when the latter is diffused within a stack of porous layers CP1 or CP8 conforming to the invention and carrying —COOH functions, or CP9 outside the invention.

FIG. 7 shows the evolution of moduli G′ and G″, as a function of time and temperature, during the RTM6 resin heat treatment step (temperature rise followed by curing), when the latter is diffused within a stack of CP8 porous layers conforming to the invention or CP9 outside the invention.

FIG. 8 shows the evolution of the viscosity of RTM6 resin alone during the heat treatment step (temperature rise followed by curing), when the RTM6 resin is diffused within a stack of CP2 or CP5 porous layers conforming to the invention and carrying —NH2 functions or CP4 outside the invention.

FIG. 9 shows the evolution of the viscosity of RTM6 resin alone during the heat treatment stage (temperature rise followed by curing) of a Huntsman tetrafunctional epoxy resin, which does not include a hardener, when the latter is diffused within a stack of CP1, CP2, CP5 or CP8 porous layers conforming to the invention, or CP9 outside the invention.

FIG. 10 shows the evolution of the viscosity and the moduli G′ and G″, as a function of time and temperature, during the heat treatment stage (temperature rise followed by curing), of Huntsman's tetrafunctional epoxy resin, which does not include a hardener, when diffused within a stack of CP8 porous layers conforming to the invention.

FIG. 11 shows the evolution of the viscosity of RTM6 resin during the heat treatment step (temperature rise followed by curing), when the resin is diffused within a stack of CP10 porous layers conforming to the invention, or layers of non-porous films made from the same polymer.

FIG. 12 shows the evolution of the gel time (duration of heating at temperature Ta until the gel point is reached) according to the isotherm temperature Ta (temperature used for resin infusion and curing) of the RTM6 resin, when the latter is diffused within a stack of CP8 porous layers conforming to the invention.

FIG. 13 shows the heating time at 180° C. required to achieve resin gelling (crossing of G′ and G″ moduli) in the case of different epoxy resins diffused in a stack of different layers (according to the invention and outside the invention), after a temperature rise at 2° C./min from 120° C. to 180° C.+2 h at 180° C.

FIG. 14 In the case of reinforcement material 2 (outside the invention), FIG. 14 shows the DMA curve obtained with and without conditioning at 70° C. for 14 days, with a temperature rise of 2° C./min from 25 to 270° C., for a composite part obtained by RTM6 resin injection.

FIG. 15 In the case of reinforcement material 5 (according to the invention), FIG. 15 shows the DMA curve obtained with and without conditioning at 70° C. for 14 days, with a temperature rise of 2° C./min from 25 to 270° C., for a composite part obtained by RTM6 resin injection.

FIG. 16 In the case of reinforcement material 6 (according to the invention),

FIG. 16 shows the DMA curve obtained with and without conditioning at 70° C. for 14 days, with a temperature rise of 2° C./min from 25 to 270° C., for a composite part obtained by RTM6 resin injection.

### EXAMPLES

### Reinforcements, Porous Layers and Resins Used

The fibrous reinforcements used in all cases are 210 g/m2 unidirectional webs, made from carbon fibers marketed by Hexcel Composites, Dagneux France, under the reference IMA 12K. The properties of these 12K fibers are summarized in Table 1 below:

TABLE 1

| | Hexcel IMA 12K |
|---|---|
| tensile force (MPa) | 6.067 |
| tensile modulus GPa | 297 |
| final elongation at break (%) | 1.8 |
| density (g/cm3) | 1.79 |
| weight/length (g/m) | 0.445 |
| filament diameter | |
| (μm) | 5.1 |

The porous polymeric layers studied are shown in Table 2 below:

TABLE 2

| | | | | | Melting | |
|---|---|---|---|---|---|---|
| Polymeric | | | COOH | NH2 | point | |
| layer | | Type of | functions | functions | layer | Other |
| (CP) | Polymer | layer | (meq/g)* | (meq/g)* | (OC) | information |
| 1 | Arkema | veil (non | 0.22 | 0.02 | 146 | |
| (invention) | copolyamide | woven) | | | | |
| 2 | Arkema | veil (non- | 0.02 | 0.34 | 106 | |
| (invention) | copolyamide | woven) | | | | |
| 3 | Arkema | veil (non | 0.11 | 0.08 | 103 | |
| (outside | Copolyamide | woven) | | | | |
| invention) | | | | | | |
| 4 | Arkema | veil (non- | — | 0.06 | 126 | |
| (outside | Copolyamide | woven) | | | | |
| invention) | | | | | | |
| 5 | Arkema | veil (non- | — | 0.34 | 128 | |
| (invention) | Copolyamide | woven) | | | | |
| 6 | epoxy | powder | | | | Used in Primetex |
| (prior art) | (thermosetting) | deposition | | | | fabric 43098 S 1020 |
| | | | | | | S E01 1F marketed |
| | | | | | | by Hexcel |
| 7 | Platamid ® | veil (non- | — | — | 105 | Layer used in the |
| (prior art) | HX2632 | woven) | | | | application |
| | copolyamide | | | | | wo 2019/102136, |
| | marketed by | | | | | before cross-linking |
| | Arkema | | | | | |
| 7a | Platamid ® | veil (non- | — | — | 100 | Layer used in the |
| (prior art) | HX2632 | woven) | | | | application |
| | copolyamide | | | | | wo 2019/102136 |
| | marketed by | | | | | |
| | Arkema partially | | | | | |
| | cross-linked | | | | | |
| 8 | Arkema | veil (non | 0.46 | 0.02 | 121 | |
| (invention) | Copolyamide | woven) | | | | |
| 9 | copolyamide | veil (non- | 0.10 | 0.12 | 160 | Veil 1R8D04 |
| (prior art) | | woven) | | | | marketed by |
| | | | | | | Protechnic used in |
| | | | | | | WO 2019/102136 |
| | | | | | | for comparison |
| 10 | Arkema | veil (non | 0.23 | — | 125 | |
| (invention) | Copolyamide | woven) | | | | |

*meq/g polymer = meq/g porous layer

Table 3 gives details of some of the polymers used to form the porous layers.

TABLE 3

| | | | | | | | | | | Raw material |
|---|---|---|---|---|---|---|---|---|---|---|
| | | | | | | | Diacids and diamines/triamines raw materials | | | for cross- |
| | | | | | | | for amine and acid functions** | | | linking** |
| | | | | | | | | | Diethylenetriamine | Undecylenic |
| Polymeric | | | | | | | Adipic | Hexamethylene- | DETA | acid |
| layer | coPA: Ratio in % mass | | | | | | acid | diamine | (multifunctional | (unsaturated |
| (CP) | 6 | 66 | 6.10 | 6.12 | 11 | 12 | DC6 | HMDA | monomer) | monoacid) |
| 1 | 35 | 30 | 35 | — | — | — | 1.3 | — | | |
| (invention) | | | | | | | | | | |
| 2 | 22 | 28 | — | — | — | 50 | — | 1.80 | — | |
| (invention) | | | | | | | | | | |
| 5 | 20 | — | — | 30 | — | 50 | — | 1.80 | — | |
| (invention) | | | | | | | | | | |
| 8 | 25 | — | — | 25 | — | 50 | 3.6 | — | 0.23 | 1 |
| (invention) | | | | | | | | | | |

**(% by weight of the formulation used for coPA formation)

The porous layers used for comparison were made with:
1) CP9: a 1R8D04 thermoplastic veil marketed by Protechnic (66, rue des Fabriques, 68702-CERNAY Cedex-France) with a melting temperature of 160° C.—this veil (hereinafter referred to as 1R8D04 veil) is meltblown and has a mass per unit area of 4 g/m2 and a thickness of 100 μm before lamination to the fibrous reinforcement. Its fibers have a diameter of 15 μm. The opening factor of such a layer is around 50%.
2) CP7: a fiber veil made from a Platamid® HX2632 polymer marketed by Arkema (a copolyamide with terminal unsaturations enabling a three-dimensional network to be obtained under UV, gamma or beta treatment) with a melting temperature of 117° C.—this veil (hereinafter referred to as HX2632 veil) is meltblown and has a mass per unit area of 4 g/m2 and a thickness of 100 μm before laminating to the fiber reinforcement. Its fibers have a diameter of 15 μm. The opening factor of such a layer is around 50%.
CP7a: a fiber veil made of a Platamid® HX2632 polymer marketed by Arkema, crosslinked under beta treatment (100 kGy, as described in application WO 2019/102136), with a melting temperature of 109° C. This meltblown veil has a mass per unit area of 4 g/m², a thickness of 100 μm before laminating to the fiber reinforcement, and is partially crosslinked under beta treatment. Its fibers have a diameter of 15 μm. The opening factor of such a layer is around 50%.
3) CP6: by depositing a layer of epoxy powder used in Primetex 43098 S 1020 S E01 1F fabric, marketed by Hexcel Composites, Dagneux France. The powder has an average diameter of 51 μm (D50, median value), and a glass transition in the 54-65° C. range.
4) CP3: a fiber veil made of a Platamid® polymer marketed by Arkema, with a melting temperature of 103° C.—this veil is meltblown and has a mass per unit area of 4 g/m2 and a thickness of 100 μm before lamination to the fiber reinforcement. Its fibers have a diameter of 15 μm. The opening factor of such a layer is around 50%.
5) CP4: a fiber veil made of a Platamid® polymer marketed by Arkema, with a melting temperature of 126° C.—this veil is meltblown and has a mass per unit area of 4 g/m2 and a thickness of 100 μm before lamination to the fiber reinforcement. Its fibers have a diameter of 15 μm. The opening factor of such a layer is around 50%.

The porous layers according to the invention were made with:
1) CP1: a fiber veil made of a Platamid® polymer marketed by Arkema, with a melting temperature of 146° C.—this veil is meltblown and has a mass per unit area of 4 g/m2 and a thickness of 100 μm before lamination to the fiber reinforcement. Its fibers have a diameter of 15 μm. The opening factor of such a layer is around 50%.
2) CP2: a fiber veil made of a Platamid® polymer marketed by Arkema, with a melting temperature of 106° C.—this veil is meltblown and has a mass per unit area of 4 g/m2 and a thickness of 100 μm before lamination to the fiber reinforcement. Its fibers have a diameter of 15 μm. The opening factor of such a layer is around 50%.
3) CP5: a copolyamide veil produced by Arkema, with a melting temperature of 128° C.—this veil is meltblown and has a mass per unit area of 4 g/m2 and a thickness of 100 μm before lamination to the fiber reinforcement. Its fibers have a diameter of 15 μm. The opening factor of such a layer is around 50%.
4) CP8: a copolyamide veil produced by Arkema, with a melting temperature of 121° C.—this veil is meltblown and has a mass per unit area of 4 g/m2 and a thickness of 100 μm before lamination to the fibrous reinforcement. Its fibers have a diameter of 15 μm. The opening factor of such a layer is around 50%.
5) CP10: a copolyamide veil produced by Arkema, with a melting temperature of 125° C.—this veil is meltblown and has a mass per unit area of 4 g/m2 and a thickness of 100 μm before lamination to the fibrous reinforcement. Its fibers have a diameter of 15 μm. The opening factor of such a layer is around 50%.

The thermosetting resins used to make composite parts are shown in Table 4 below:

TABLE 4

| | | Main characteristics |
|---|---|---|
| Resin Type | | Temperature |
| Commercial reference | Supplier | and curing times |
| exFlow ® RTM6 | Hexcel Composites | 180° C., 90 minutes |
| tetrafunctional epoxy | | minimum |
| exFlow ® HF620 | Hexcel Composites | 180° C., 2 hours |
| tetrafunctional epoxy | | |
| Prism ® EP2400 | Solvay | 180° C., 2 hours |
| trifunctional epoxy | | |
| Prism ® EP2410 | Solvay | 180° C., 2 hours |
| trifunctional epoxy | | |

### Recommended on Product Sheet

Methods for determining the quantity of —NH2 and —COOH functions:

The quantity of reactive —COOH or —NH2 functions present can be assessed by potentiometric titration: the quantity of —COOH functions is determined by acid-base titration of the porous layer with tetra-n-butylammonium hydroxide ((C₄H₉)₄N⁺OH⁻TBAOH) in alcoholic solution, that of —NH2 functions is determined by titration with perchloric acid (HClO₄) in acetic acid. Results are expressed in meq/g of polymer evaluated. The method described in document AB-068 entitled “Potentiometric determination of carboxyl and amino end groups in polyesters and polyamides” by Metrohm details the potentiometric titration procedure used to determine the carboxylic acid and amine functions present.

The reagents used for the assay are as follows:
TBAOH (concentration 0.1 mol/L in isopropanol)=reactive titrant for COOH reactive functions,
HClO₄ (concentration 0.1 mol/L in glacial acetic acid)=reactive titrant for NH₂ reactive functions,
benzyl alcohol.

To determine the amount of COOH reactive functions, between 0.5 and 1.5 g of sample is weighed into a beaker, mixed with 100 mL benzyl alcohol and diluted by heating to boiling point. After cooling to around 80-100° C., titration is performed with TBAOH. The end of the burette is just slightly immersed in the solution. A blank value (i.e. with no sample added) is determined under the same conditions.

To determine the amount of NH reactive functions₂, between 0.5 and 1.0 g of sample is weighed into a beaker, mixed with 100 ml of benzyl alcohol and diluted by heating to boiling point. After cooling to around 80-100° C., titration is performed with perchloric acid HClO₄. The end of the burette is just slightly immersed in the solution. A blank value is determined under the same conditions.

The amount of reactive functions is then calculated according to the formula:

Quantity of reactive functions

$$( COOH or NH 2 , in μ eq / kg ) = \frac{( A - B ) \times t \times 100}{E}$$

Where A is the sample titrant consumption in mL, B the blank titrant consumption in mL, t the titrant titre and E the sample mass in g.

The titre of the titrant is determined by potentiometry in accordance with Metrohm bulletin 206/5 e “Titer determination in potentiometry”. For TBAOH, benzoic acid is generally used; for HClO4, TRIS (tris-hydroxymethyl)-amino-methane) is generally used.

### Laminating Veils—Obtaining a Veiled UD Reinforcement Material

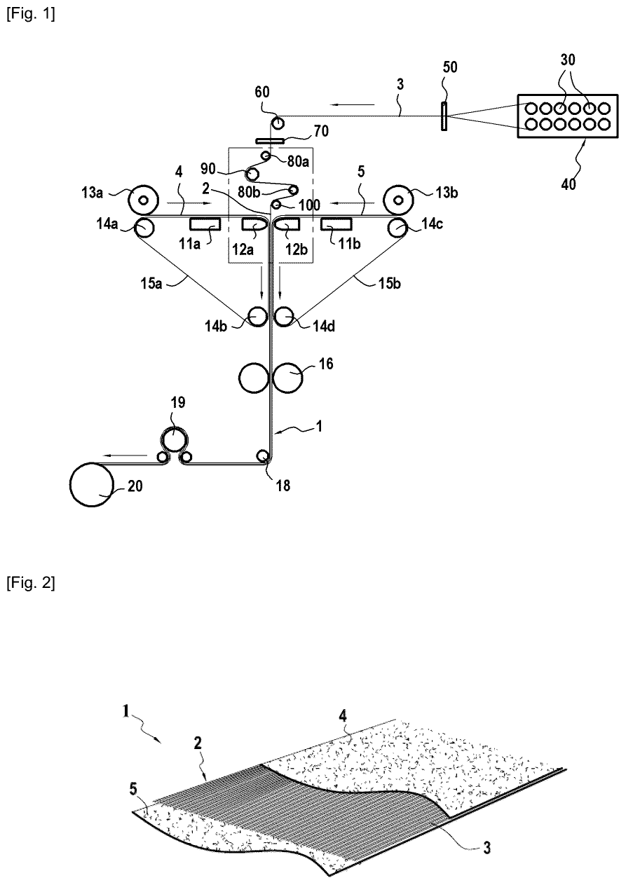

The veils are associated with the unidirectional web of carbon yarns using a production line employing a machine as described in application WO 2010/061114 and re-detailed below, with reference to FIG. 1. The resulting reinforcement material 1 is schematically shown in FIG. 2: it consists of a unidirectional web 2 of carbon yarns 3 associated on each of its faces with a veil 4,5, the association having been achieved thanks to the hot tackiness of the thermoplastic veils 4,5.

The carbon yarns 3 are unwound from corresponding spools 30 of carbon yarns fixed on a creel 40, pass through a comb 50, are guided in the axis of the machine by means of a guide roller 60, a comb 70 and a guide bar 80a.

The carbon yarns 3 are preheated by a heating bar 90 and then spread by the spreading bar 80b and heating bar 100 to the desired carbon mass per unit area for the unidirectional web 2. The rolls 13a and 13b of veils 4 and 5 are unwound without tension and transported by means of continuous belts 15a and 15b fixed between the free-rotating, non-motorized rolls 14a, 14b, 14c, 14d and the heating bars 12a, 12b. The veils 4 and 5 are preheated in zones 11a and 11b before coming into contact with the carbon yarns 3 and laminated on either side of two heating bars 12a and 12b whose air gap is controlled. A calender 16, which can be cooled, then applies pressure to the unidirectional web with a veil on each side, leading to the reinforcing material 1 in ribbon form. A return roller 18 redirects the reinforcing material 1 to the traction system, which comprises a motor-driven take-up 19 and winding trio 20, to form a roll from the reinforcing material 1 thus formed.

### Tests Carried Out

### I. Measurements

DSC: Differential Scanning Analysis. Analyses were performed on a Discovery 25 instrument from TA Instruments, Guyancourt, France.
DMA: Dynamic Mechanical Analysis. Analyses were carried out on a Q800 instrument from TA Instruments, Guyancourt, France, in accordance with standard EN 6032 (1 Hz, 1° C./min, Amplitude 15 μm).
Hot microscope analysis: Analyses were carried out on an Axio M2m Microscope Imager from Zeiss, Marly-le-roi, France, equipped with a heating system from Linkam Scientific Instruments, Tadworth, UK.
Rheology: Viscosity analyses were carried out on a HAAKE Mars 60 rheometer from Thermofisher Scientific, Courtaboeuf, France. Analyses were carried out in accordance with EN6043 at 2° C./min, 10 rad/s, but at a strain of 4% rather than 10%.

### II. Influence of the Level of Reactive Functions on Mobility in RTM6 Resin

A porous layer (CP) to be studied and RTM6 epoxy resin applied to said porous layer are placed between two glass slides, the whole being itself placed under an optical microscope. The whole assembly is then subjected to a temperature rise of 2° C./min up to a temperature of 180° C., corresponding to the final temperature when the RTM6 epoxy resin is infused or injected during the production of a composite part. This is the critical cycle for the temperature resistance of the CP layer, since no pre-crosslinking of the resin is employed.

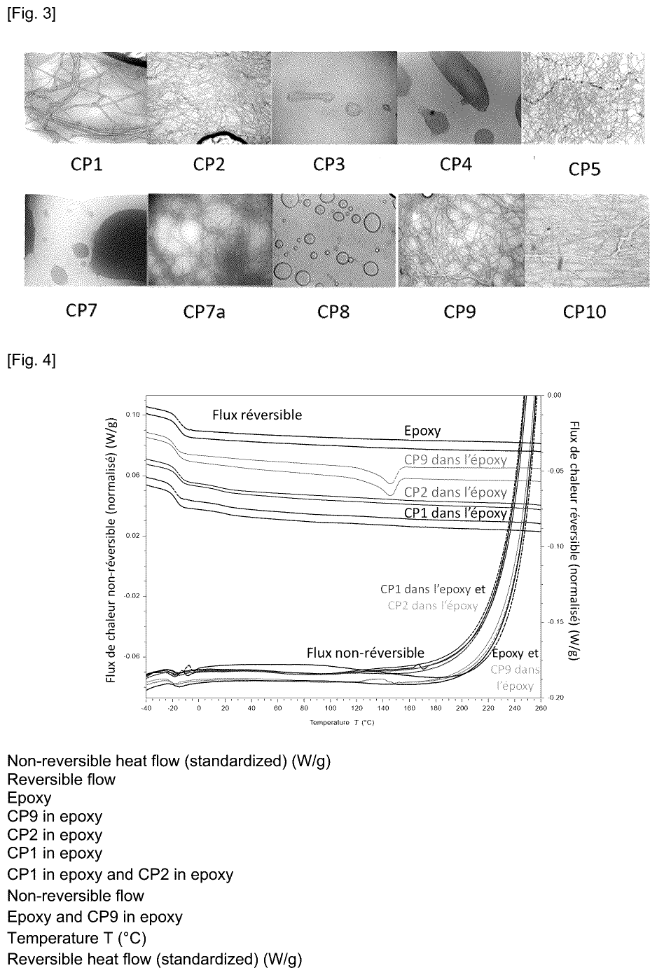

FIG. 3 shows images obtained at 180° C., i.e. post-crosslinking of the resin. It can be seen that the veil dissolves or completely loses its integrity in the resin in the case of the CP3, CP4 and CP7 layers, which do not correspond to the definition of the invention. It also appears that the veil loses its integrity in the resin, in the case of the CP8 layer which corresponds to the invention, a sign that reactivity and integrity of the porous layer are decorrelated. However, a reduction in the mobility of the porous layer in the resin is still observed, which is sufficient.

It is quite clear that, on the one hand, the presence of —NH2 functions in a porous layer, corresponding to a quantity greater than 0.15 meq/g, enables it to retain its integrity in contact with the epoxy resin, even when the temperature reached is well above its melting point (porous layers CP2 and 5), in the same way as the porous layer CP7a formed with a partially cross-linked thermoplastic polymer. The preservation of this integrity clearly shows that a reaction has taken place between the porous layer and the resin.

Similarly, a quantity of —COOH functions in the porous layer greater than 0.20 meq/g is required for reactivity in contact with the epoxy resin (porous layers CP1, CP8 and CP10), but this does not automatically imply the preservation of its integrity. A reduction in the mobility and dissolution of the porous layer in the resin is nevertheless observed, which clearly shows that a reaction has taken place between the porous layer and the resin. These observations therefore highlight the fact that the reaction between the porous layer and the epoxy resin can lead to a more or less marked maintenance of the porous layer's integrity. Further studies were carried out to determine the reaction or absence of reaction between the porous layers studied and the resin.

### III. Demonstrating the Reactivity of Porous Layers on Epoxy Functions

Various results were obtained with porous layers and a Huntsman tetrafunctional epoxy, which does not include a hardener:
Modulated differential scanning calorimetry (MDSC)
Planar rheology.

### Modulated Differential Scanning Calorimetry (MDSC)

Approximately 2 mg of porous layer were impregnated with about 18 mg of epoxy, and the assembly was placed in a hermetically sealed aluminum DSC capsule, which was then pierced. The resulting capsules were then placed in an oven and subjected to a temperature cycle equivalent to the conventional cycles used during the production of a composite part by infusion or injection: 1 h 120° C.+2 h 180° C. with a temperature rise of 2° C./min. After curing, the samples were slowly cooled naturally to room temperature.

The resulting samples were then analyzed by MDSC at 2° C./min, to differentiate between reversible phenomena (epoxy and veil glass transitions, veil melting) and irreversible phenomena (exothermic resin crosslinking). The results are shown in FIG. 4.

The first observation is that the curing cycle has no impact on the epoxy, as the MDSC curve remains unchanged, with a glass transition of the order of −15/−20° C. On the other hand, it is clear that in the event of reactivity between the porous layer and the epoxy during the curing cycle, the porous layer is no longer able to recrystallize and therefore no longer shows a melting point in the MDSC analysis (porous layers CP1 and 2). Conversely, when the porous layer does not react with the epoxy, it is able to recrystallize on cooling, as indicated by the melting point of porous layer CP9 visible at around 150° C.

A second observation is the initiation of epoxy cross-linking at high temperature, which occurs 10 to 20° C. earlier when the resin has been able to partially react with the porous layer.

Finally, a slight glass transition is observed at around 10-20° C. when the porous layer is able to react with the epoxy. This glass transition could be that of a portion of the epoxy having initiated cross-linking with the porous layer.

### Planar Rheology

A 35 mm-diameter disc with 0.12 g of porous layer was prepared by stacking several plies of porous layer. The resulting disk was then dipped in RTM6 epoxy resin to fully impregnate it, then positioned on the rheometer's bottom plate. Excess resin was then removed as the top plate was lowered, until an air gap of 0.5 mm was obtained, within which the porous layer sample impregnated with epoxy resin was located.

The imposed strain was 4% and the shear frequency 10 rad/s, in accordance with standard EN6043, and the curing cycle was a one-hour isotherm at 120° C., followed by a 2° C./min rise to 180° C. for 2 hours.

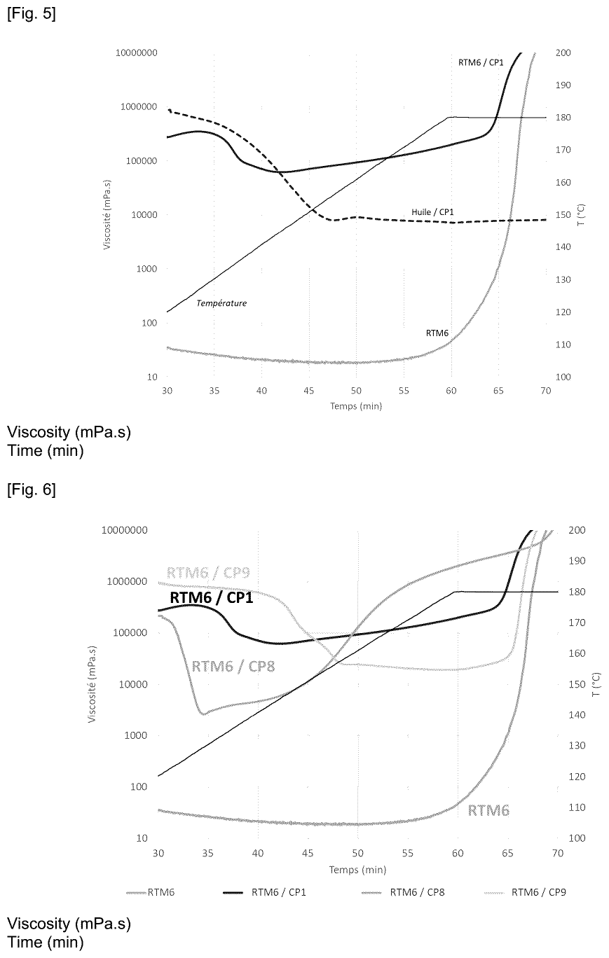

FIG. 5 shows the evolution of viscosity during curing, and it is clear that after melting of the CP1 porous layer, viscosity increases progressively, whereas in the absence of the porous layer, the viscosity of RTM6 resin remains stable, even decreasing slightly as the temperature rises before cross-linking takes place. To ensure that the increase in system viscosity in the presence of the CP1 porous layer was due solely to the porous layer, the same test was also carried out by immersing the porous layer in an oil of identical viscosity to RTM6 at 120° C. (PMX-50 oil). It was then observed that the CP1 porous layer melted to a greater extent (the viscosity level dropped by 2 décades compared with one decade in RTM6) and that the viscosity of the mixture then remained constant. This observation therefore confirmed that the observed increase in the viscosity of the RTM6 porous layer/resin system, which followed the melting of the porous layer, was due to reactions between the RTM6 resin (and more specifically its epoxy function) and the CP1 porous layer (and more specifically its reactive functions —COOH).

FIG. 6 shows the same type of results, but in the presence of different porous layers with —COOH functions: CP1 and CP8 conforming to the invention and CP9 carrying only 0.10 meq/g of —COOH functions and 0.12 meq/g of —NH2 functions, therefore outside the invention.

These results clearly show that by controlling the amount of —COOH functions in the porous polyamide layers, it is possible to control the level of reaction of these with the epoxy resin.

Shear rheology can also be used to monitor cross-linking, since at the gel point (or gelling point), the storage modulus G′ and the loss modulus G″ are equivalent. The gel point thus corresponds to the intersection between the two curves G′ and G″.

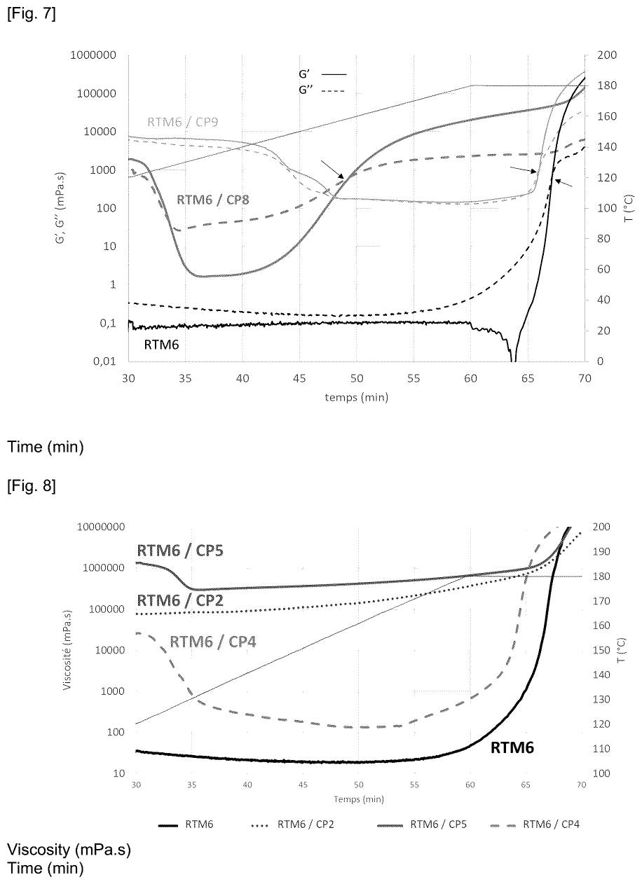

By increasing the level of —COOH functionalities in the porous layers (CP8), it is possible to achieve cross-linking between the porous layer and the RTM6 resin, as indicated by the crossing of the G′ and G″ moduli after 50 minutes of experimentation and at 158° C. (FIG. 7). In the presence of the CP9 porous layer, the gel point of RTM6 remains virtually unchanged, confirming that the porous layer does not react with the resin.

Similarly, FIG. 8 shows the evolution of viscosity in the presence of different porous layers with —NH2 functions. Once again, by increasing the level of —NH2 functions in porous polyamide layers, it is possible to control the level of reaction between them and the epoxy resin.

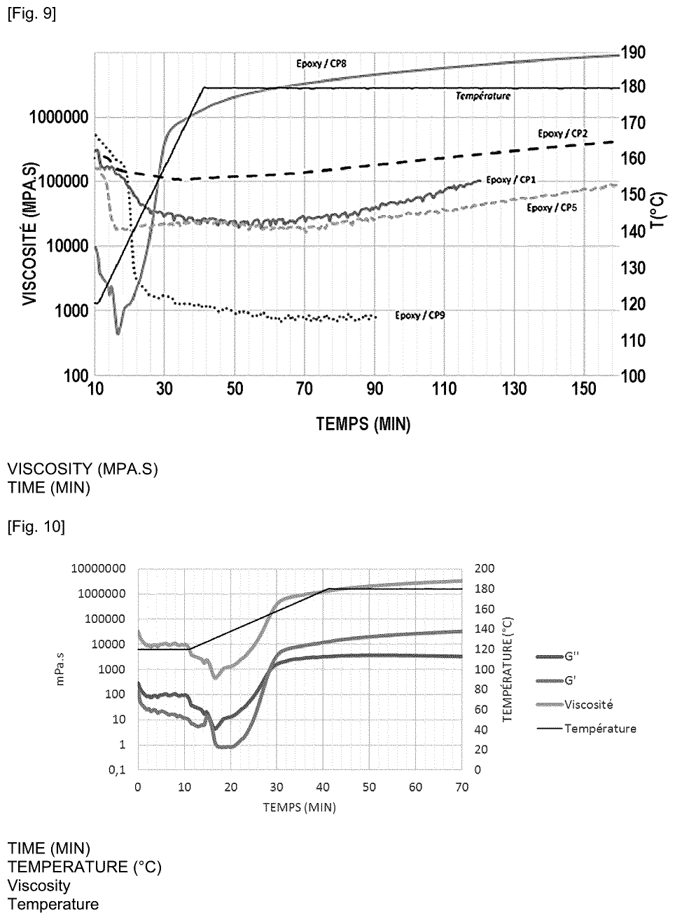

These results were complemented by a second series of experiments in which the porous layers studied were immersed not in RTM6 resin, but in a Huntsman tetrafunctional epoxy, which does not include a hardener, so as to better highlight the reactions between the reactive functions of the polyamide and the epoxy, which could be masked by the presence of the hardener within the RTM6 resin, since the kinetics of the epoxy/hardener reaction are faster than those of the epoxy alone. Test conditions were otherwise strictly identical, and the results obtained are shown in FIG. 9, enabling us to monitor any gelling of the epoxy/polyamide system. With the CP8 layer, a clear increase in viscosity is observed as the temperature rises (FIG. 9), but it also appears that the G′ and G″ moduli cross (FIG. 10) after 28 minutes of temperature rise at 155° C. It is important to note that the epoxy resin alone gels after more than 11 h at 180° C., which also confirms that the gel point observed in FIG. 10 results from the reaction between the porous layer and the epoxy. For the other CP1, CP2 and CP5 layers, no change in the gel point of the epoxy is observed, however, a limitation of the melting of the porous layer as well as an increase in the viscosity of the mixture is observed, indicative of a reaction between the reactive functions and the epoxy. On the contrary, the CP9 layer melts markedly and the viscosity of the mixture remains constant during the test, indicating an absence of interaction or reactivity (FIG. 9).

### IV. Absence of Influence of Porous Layer Structure on Epoxy Reactivity of RTM6 Resin

The polyamide of porous layer 10 (CP10) in non-woven form was also tested in the form of a non-porous film 100 μm thick, in order to assess whether the structure of the polyamide layer used had any influence on its reactivity with the epoxy of RTM6 resin. FIG. 11 (which shows the evolution of viscosity during a temperature rise at 2° C./min from 120° C. to 180° C. 2 h of epoxy/polyamide samples according to the structure of the porous layer or polyamide film) shows that the structure of the layer has no influence on its reactivity with epoxy. Thus, the accessibility of the —COOH functions of the polyamide remains the same whether it is in the form of a non-woven fabric (CP10), or a non-porous film.

### V. Reactivity of the Porous Layer at Temperatures Below its Melting Point

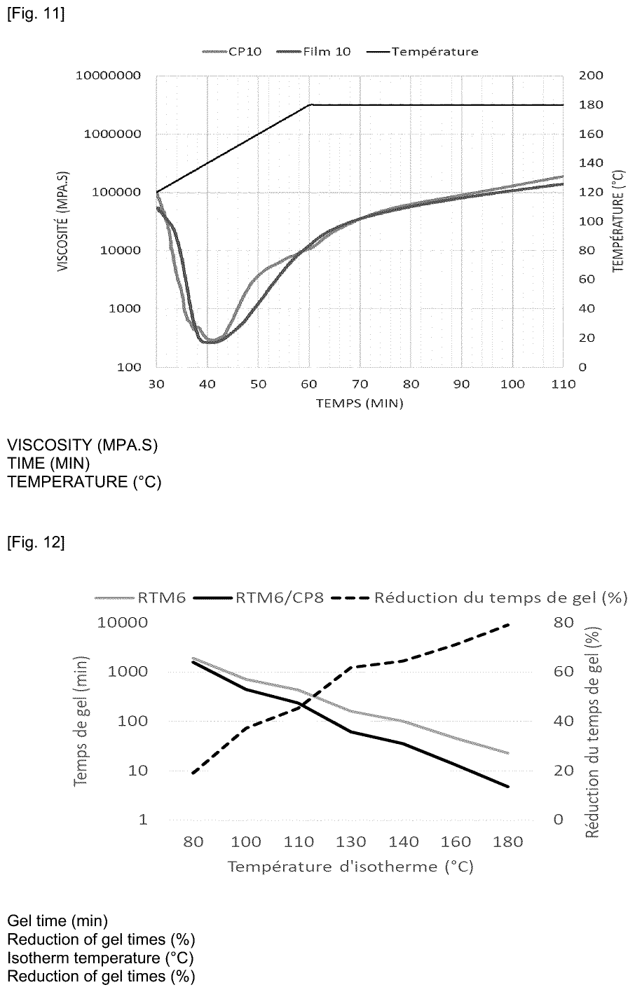

The ability of the porous layer to react with RTM6 resin below its melting point was validated with the CP8 porous layer. FIG. 12 shows the evolution of the gel time (duration of heating at temperature Ta until the gel point is reached) according to the isotherm temperature Ta (temperature used for resin infusion and curing), applied during the test for an RTM6 sample and an RTM6/porous layer CP8 sample. FIG. 12 shows that the porous layer can react and modify the gel point of RTM6, even below its melting point. Thus, while it is clear that the reaction kinetics of the CP8/RTM6 porous layer are accelerated when the two materials are brought into contact above the melting point of the porous layer (resulting in greater mobility of the porous layer and thus increased accessibility of the —COOH functions of the polyamide), reaction is also possible below the melting point.

### VI. Application to Various Commercial Resins

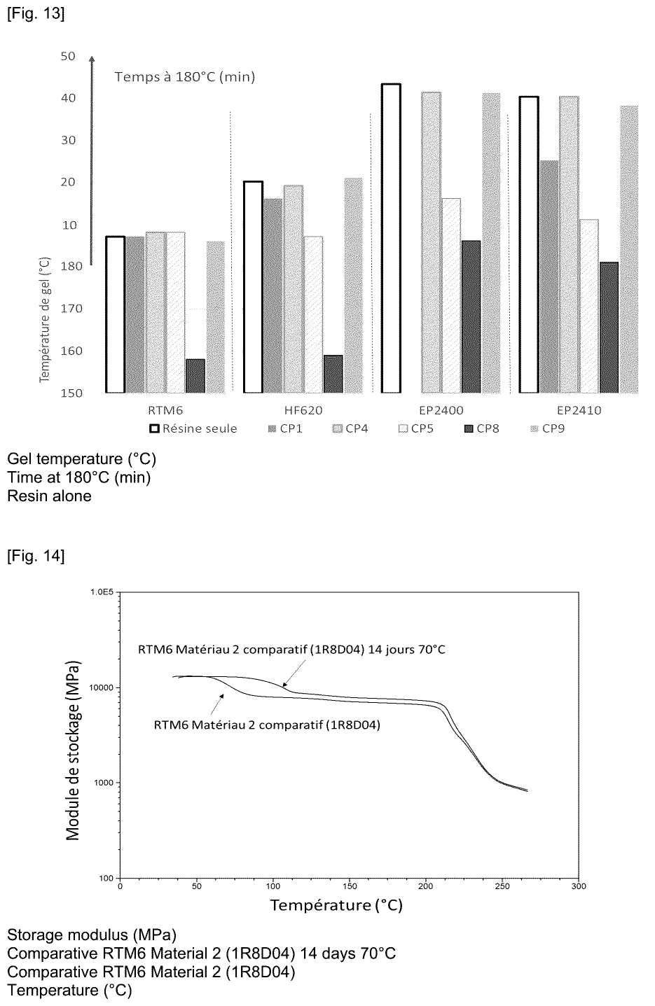

The various porous layers were immersed in the four commercial resins described above, namely RTM6, HF620, EP2400 and EP2410. The gel point was then measured as the intersection of the G′ and G″ moduli during a temperature rise at 2° C./min from 120° C. to 180° C.+2 h at 180° C. FIG. 13 shows the results obtained. When gelling occurs during the heating phase at 180° C., the difference is in the heating time required to achieve gelling, which is shown in the upper part of FIG. 13.

The difference in reactivity between RTM6 and HF620 resins, on the one hand, and EP2400 and EP2410 resins, on the other, is clearly apparent, and is reflected in the very different time required to achieve gelling at 180° C. The reduced reactivity of the resin gives the porous layers more time to react. Thus, although reactions between the reactive functions and the epoxy occur as previously demonstrated, the porous layers CP1 (carrying —COOH functions, conforming to the invention) and CP5 (carrying —NH2 functions, conforming to the invention) have no influence on the gel point of RTM6. On the other hand, with these same layers, the gel point is modified for HF620 resin, and even more so for EP2400 and EP2410 resins. Thus, due to the slower epoxy/hardener reaction kinetics in the case of HF620, EP2400 and EP2410 resins, the reactions between the reactive functions and the epoxy have a greater impact on the resin's gel point. In any case, whether or not the gel point is modified, in the case of RTM6 resin, with the porous layers according to the invention, there are reactions between the reactive functions carried by the said layers and the epoxy resin, as previously demonstrated and which also materialize in a maintenance of the mechanical properties, as shown in paragraph IV below. Conversely, with CP4 and CP9 porous layers (outside the invention), there is no change in gel point, whatever the resin: EP2400 and EP2410 or RTM6 and HF620. This confirms that in this case, there is no reaction with the epoxy resin.

These results also highlight the influence of the epoxy functionality of the resins tested. Whereas in the case of RTM6 and HF620 resins the epoxies are tetrafunctional, in the case of EP2400 and EP2410 resins they are trifunctional. This means that there are fewer epoxy groups accessible in the case of these two resins, resulting in slower reactivity with the porous layers, particularly visible in the case of porous layer CP8, which reacted particularly rapidly with RTM6 and HF620 resins. This does, however, leave time for the other porous layers (CP1, CP5) to react.

### VII. Influence of Porous Layer Reactivity on Composite Mechanical Properties

Seven reinforcement materials presented in Table 5 were compared, four according to the invention and four for comparative purposes.

TABLE 5

| | | | Material 3 | Material 4 |
|---|---|---|---|---|
| | Comparative | Comparative | according to | according to |
| | material 1 | material 2 | the invention | the invention |
| Porous | Primetex fabric | Veil 1R8D04 | CP1 | CP2 |
| layer | epoxy powder | (CP9) | | |
| | (CP6) | | | |
| | Material 5 | Material 6 | | |
| | according to | according to | Comparative | Comparative |
| | the invention | the invention | material 7 | material 7a |
| Porous | CPS | CPS | CP7 | CP7a |
| layer | | | | |

The conditions used to manufacture unidirectional carbon webs associated with a porous layer on each side are shown in Table 6 below.

TABLE 6
Process parameters for implementing unidirectional
webs associated with a veil on each side

| | | | | | T sail | |
|---|---|---|---|---|---|---|
| | Measured mass | | | | preheating | T bars |
| | per unit area of | Line | T bars | T bar | (° C.) | (° C.) |
| | unidirectional | speed | (° C.) | (° C.) | (11a & | (12a & |
| Material | (g/m2) | (m/min) | (90) | (100) | 11b) | 12b) |
| 2 | 210 | 2.4 | 200 | 200 | 160 | 180 |
| 3 | 210 | 2.4 | 60 | 65 | 85 | 100 |
| 4 | 210 | 2.4 | 60 | 65 | 85 | 100 |
| 5 | 210 | 2.4 | 60 | 65 | 85 | 100 |
| 6 | 210 | 2.4 | 60 | 65 | 85 | 100 |
| 7 | 210 | 2.4 | 60 | 65 | 85 | 100 |
| 7a | 210 | 2.4 | 60 | 65 | 85 | 100 |

A 340 mm×340 mm preform consisting of the stacking sequence adapted to the carbon grammage was placed in an injection mold under press. A frame of known thickness surrounding the preform made it possible to obtain the desired fiber volume ratio FVR.

The epoxy resin marketed by Hexcel under the reference HexFlow RTM6 was injected at 80° C. under 2 bars through the preform, which was maintained at 120° C. inside the press. The pressure applied by the press was 5.5 bar. Once the preform had been filled and the resin had exited the mold, the outlet pipe was closed and the heat treatment cycle initiated: 3° C./min to 180° C., followed by 2 h heating to 180° C. and cooling to 5° C./min.

Specimens were then cut to the appropriate dimensions to perform the compression after impact (CAI), in-plane shear (IPS) and open hole compression (OHC) tests summarized in Table 7.

TABLE 7

| | IPS | CAI | OHC |
|---|---|---|---|
| Preform ply | [45/135]2s | [45/0/135/90]3s | [45/0/135/90]3s |
| orientation | | | |
| Test machine | Instron 5582 | Zwick Z300 | Zwick Z300 |
| EN standard | 6031 | 6038 | 6036 |

The results obtained for all these tests are listed in Tables 8 to 10. The mechanical results presented show that the results according to the invention enable composite parts to be obtained with optimum properties, particularly in terms of impact resistance (CAI), the mechanical properties showing sensitivity to holes such as open hole compression (OHC) or in-plane shear (IPS).

On the one hand, although epoxy powder (comparative material 1) solves the problem of carrying out all the steps in the dry preform production process at temperatures between 8° and 130° C., it does not produce composite parts with optimum mechanical properties. On the other hand, conventional polyamide veil (comparative material 2) provides optimum mechanical properties, but requires higher temperatures for manufacture and shaping. In contrast, the materials according to the invention address both issues.

Materials 3 to 6 according to the present invention therefore make it possible to combine both a manufacturing and shaping process at temperatures below 130° C. and optimum mechanical properties on composite parts. It should also be emphasized that mechanical performance is comparable whatever the material used in the invention, even if the integrity of the porous layer is lost and only the mobility of the porous layer is reduced (material 6 with CP8 layer), or even if the porous layer does not modify the gel time of the RTM6 resin (material 3 with CP1 layer or material 5 with CP5 layer). So, in all cases, with materials according to the invention, the reactive/epoxy function reactions are sufficient to avoid deteriorating the mechanical properties of the composite part obtained, due to the presence of the porous layer, despite its low melting point. Similarly, it can be seen that with materials according to the invention, the mechanical properties are equivalent to the properties obtained with the comparative material 7a whose thermoplastic CP7a layer is partially cross-linked.

IPS performance is also improved over the comparative material 7.

TABLE 8
IPS

| | | | Material 3 | Material 4 |
|---|---|---|---|---|
| | Comparative | Comparative | according to | according to |
| IPS | material 1 | material 2 | the invention | the invention |
| Module | 4.1 | 4.4 | 4.5 | 4.4 |
| (dry, 23° C.) | | | | |
| (GPa) | | | | |
| 0.2% stress | 39 | 38 | 39 | 40 |
| (dry, 23° C.) | | | | |
| (MPa) | | | | |
| Module | 3.6 | 3.4 | 3.8 | 3.8 |
| (dry 90° C.) | | | | |
| (GPa) | | | | |
| 0.2% stress | 32 | 29 | 31 | 32 |
| (dry 90° C.) | | | | |
| (MPa) | | | | |
| | Material 5 | Material 6 | | |
| | according to | according to | Comparative | Comparative |
| IPS | the invention | the invention | material 7 | material 7a |
| Module | 4.6 | 4.6 | 4.2 | 4.6 |
| (dry 23° C.) | | | | |
| (GPa) | | | | |
| 0.2% stress | 41 | 41 | 40 | 41 |
| (dry 23° C.) | | | | |
| (MPa) | | | | |
| Module | 3.5 | 3.6 | 2.9 | 3.9 |
| (dry 90° C.) | | | | |
| (GPa) | | | | |
| 0.2% stress | 30 | 30 | 25 | 33 |
| (dry, 90° C.) | | | | |
| (MPa) | | | | |

TABLE 9
OHC

| | | | Material 3 | Material 4 |
|---|---|---|---|---|
| OHC | Comparative | Comparative | according to | according to |
| compression | material 1 | material 2 | the invention | the invention |
| dry, 23° C. | 257 | 285 | 300 | 285 |
| (MPa) | | | | |
| dry, 90° C. | 228 | 228 | 218 | 218 |
| (MPa) | | | | |
| | Material 5 | Material 6 | | |
| OHC | according to | according to | Material 7 | Comparative 7a |
| compression | the invention | the invention | comparison | material |
| dry, 23° C. | 291 | 292 | 285 | 295 |
| (MPa) | | | | |
| dry, 90° C. | 220 | 210 | 99 | 238 |
| (MPa) | | | | |

As can be seen from Table 9, OHC performance is the same or even better with materials according to the invention.

TABLE 10
CAI

| CAI | | | | |
|---|---|---|---|---|
| normalized to | | | Material 3 | Material 4 |
| 60% FVR | Comparative | Comparative | according to | according to |
| (dry, 23° C.) | material 1 | material 2 | the invention | the invention |
| 30J (MPa) | 126 | 259 | 293 | 290 |
| 70J (MPa) | — | 192 | 241 | 237 |
| CAI | | | | |
| normalized to | Material 5 | Material 6 | | |
| 60% FVR | according to | according to | Comparative | Comparative |
| (dry, 23° C.) | the invention | the invention | material 7 | material 7a |
| 30J (MPa) | 264 | 264 | 167 | 255 |
| 70J (MPa) | — | — | — | 211 |

With the materials according to the invention, the CAI performances shown in Table 10 are better than those obtained with the comparative materials 1 and 7, which have comparable melting points. On the other hand, they are comparable to those obtained with comparative material 2, which requires higher-temperature shaping.

### VIII. Influence of Porous Layer Reactivity on Stability During Temperature Conditioning

The tests carried out showed that a composite part obtained by associating a reinforcing material comprising a thermoplastic porous layer and RTM6 resin had two transitions when subjected to temperature stress. The first transition corresponds to the glass transition of the porous thermoplastic layer enriched with epoxy resin and occurs at temperatures below 100° C., while the second transition corresponds to the glass transition of the epoxy matrix and occurs at temperatures of around 200° C.

Most aging of composite materials in contact with aggressive fluids takes place at temperatures of up to 70° C., with contact times of varying lengths. When comparative material 2 (with a CP9-1R8D04 porous layer) was aged at 70° C., a change in the glass transition of the epoxy resin-enriched thermoplastic porous layer was observed, due to phase separation and curing of the epoxy resin. An example of the results is shown in FIG. 14, which illustrates the material's response to DMA stress (DMA curves obtained with and without conditioning for 14 days at 70° C.: 2° C./min from 25 to 270° C.). The transition changes markedly from approx. 60° C. to approx. 100° C. during aging at 70° C., whereas the glass transition of RTM6 does not change (not shown).

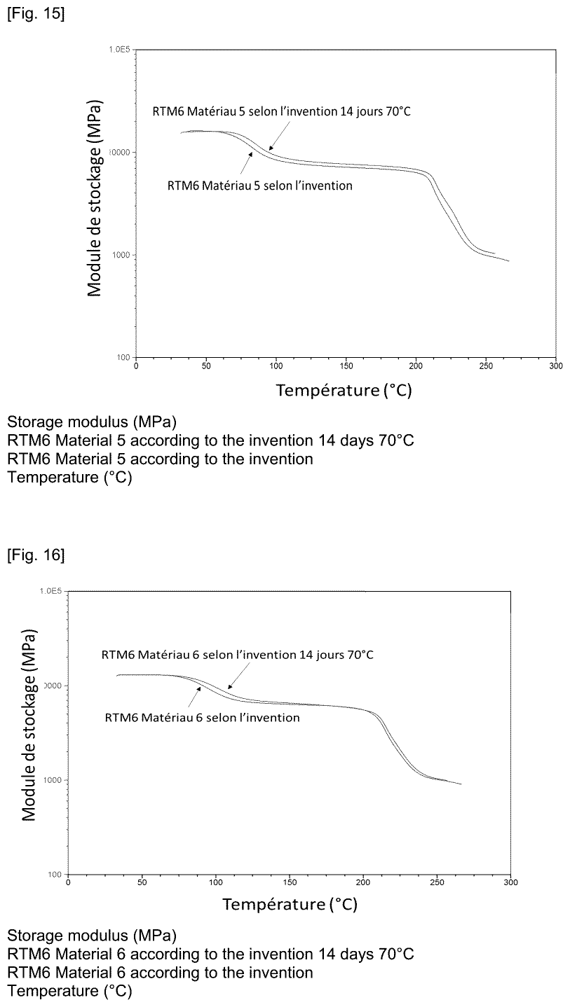

Conversely, when using the porous layers according to the invention in materials 5 and 6 according to the invention (FIG. 15 and FIG. 16 respectively), it is clear that the glass transition of the thermoplastic porous layer, which may have reacted with the epoxy resin, remains relatively stable when aged at 70° C. This is because there is no phase separation between the two chemically reacted materials when the RTM6 resin is cured. This is because there is no phase separation between the two chemically-reacted materials when the RTM6 resin is cured.

This confirms the results obtained by optical microscopy and shows that the reactions between the porous layers according to the invention and the resin minimize the impact of the presence of said porous layer on the properties of the resin, despite its low melting point. This is one of the interests of the invention, since it appears that the presence of the porous layers recommended in the invention has no impact on the thermomechanical properties of the thermosetting resin.

1. (canceled)

2. (canceled)

3. (canceled)

4. The reinforcing material of claim 26, characterized in that the reactive thermoplastic polymer is a polyamide or copolyamide carrying said —NH2 and/or —COOH functions.

5. (canceled)

6. The reinforcing material of claim 4, characterized in that the reactive thermoplastic polymer has a number-average molecular weight Mn greater than 4000 g/mol.

7. (canceled)

8. (canceled)

9. (canceled)

10. (canceled)

11. (canceled)

12. The reinforcing material of claim 6, characterized in that the unidirectional webs of reinforcing yarns are associated with one another or with the at least one layer of porous thermoplastic layer by sewing, knitting or needling.

13. The reinforcing material of claim 12, characterized in that said at least one layer of porous thermoplastic material comprise a non-woven or veil, and further comprising a powder deposit.

14. (canceled)

15. (canceled)

16. The preform comprising, one or more layers of reinforcing material according to claim 13.

17. The method of manufacturing a composite part from a preform according to claim 16, characterized in that an epoxy thermosetting resin is injected or infused into said preform.

18. (canceled)

19. (canceled)

20. (canceled)

21. (canceled)

22. (canceled)

23. (canceled)

24. (canceled)

25. (canceled)

26. A reinforcing material comprising:
(a) at least one layer of fibrous reinforcement having a planar configuration;
(b) at least one layer of porous thermoplastic material, said at least one layer being conjoined to one or both of the planar surfaces of said fibrous reinforcement, said at least one layer of thermoplastic material representing from 2 to 6% of the total mass of the reinforcing material;
said fibrous reinforcement comprising a unidirectional web of yarns, a woven fabric, or a stack of unidirectional webs of reinforcing yarns bonded together by needling or other physical means;
wherein said porous thermoplastic layers are formed from reactive thermoplastic carrying —NH2 functions in a quantity from 0.20 to 0.95 meq/g of reactive thermoplastic polymer and carry —COOH functions in a range from 0.20 to 0.95 meq/g of reactive thermoplastic polymer.
